(19) United States
(12) Patent Application Publication
(10) Pub. No.: US 2003/0034995 A1
(43) Pub. Date: Feb. 20, 2003

(54) Interactive graphics-based analysis tool for visualizing reliability of a system and performing reliability analysis thereon

(76) Inventors: Brock Estel Osborn, Niskayuna, NY (US); Radu Eugen Neagu, Albany, NY (US); Alissa Beth Krupar, Erie, PA (US); John Erik Hershey, Ballston Lake, NY (US); Kati Illouz, Schenectady, NY (US); Carl Harold Hansen, Latham, NY (US); Melvin Craig Edgar JR., Cincinnati, OH (US); James Ernest Dockendorff, Cincinnati, OH (US); Donald Lee Gardner, West Chester, OH (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/897,556

(22) Filed: Jul. 3, 2001

(51) Int. Cl. G09G 5/00

(52) U.S. Cl. 345/713

(57) ABSTRACT

An interactive graphics-based analysis tool for performing reliability analysis of a system formed from a variety of subsystems and components within each subsystem. The tool uses a hierarchical representation component to organize the system, subsystems and components into a hierarchical representation. An interactive selection component provides different options for analyzing the hierarchical representation. A reliability analysis component, responsive to the hierarchical representation component and the interactive selection component, allows a user to perform a reliability analysis at any level of the hierarchical representation.

### BACKGROUND OF THE INVENTION

This disclosure relates generally to improving quality of products and systems and more particularly to providing an interactive graphics-based tool for visualizing the reliability associated with complex systems as well as performing various types of reliability analysis on such systems.

Reliability is a very broad term that focuses on the ability of a product to perform its intended function. From a mathematical point of view, reliability is the probability that a product or system will perform its intended function without failure for a specified period of time under stated conditions. Performing a reliability analysis on a product or system can include a number of different analyses that determine how reliable the product or system is. As more companies become concerned with the servicing of their products and systems, it becomes necessary to have an understanding of the reliability of the products and systems. This becomes even more necessary for complex systems such as locomotives, aircraft engines, automobiles, turbines, computers, appliances, etc., where there are many subsystems each having hundreds of replaceable units or components. If there is an understanding of the reliability of the systems, then future failures can likely be anticipated and any downtime associated with correcting the failures can likely be kept to a minimum. Furthermore, this understanding will allow a company to make design changes and corrections to systems and components in order to improve reliability.

Currently, there are several software packages that allow system engineers to perform reliability analyses of a system, however, these packages do have their disadvantages. For example, in many cases, subsets of data associated with the system being analyzed must be “copied and pasted” into the software package and various tools within the package must be used to modify the data before it can be properly analyzed. Some tools allow the user to construct block diagrams of the system and enter parametric values for the reliability of each component of the block diagram. These software tools then allow the user to obtain system level reliability based on a roll-up of the components in the block diagram, utilizing either analytical or simulation based methods. Unfortunately, these tools lack true integration of a database of historical information and the tool used to analyze the data. Furthermore, these tools do not allow the user to interact with the data in a graphical framework in order to perform various types of reliability analysis at various levels of the system hierarchy.

In order to overcome the above problems, there is a need for an interactive graphics-based tool that allows modeling of a complex system in a hierarchical representation and performing reliability analyses at any level of the representation. Furthermore, there is a need for this tool that allows integration with a database of historical information.

### BRIEF SUMMARY OF THE INVENTION

In one embodiment of this disclosure, there is an interactive graphics-based tool, method and computer readable medium that stores instructions for instructing a computer system, to perform a reliability analysis on a system having a plurality of subsystems and a plurality of components within each subsystem. In this embodiment, a hierarchical representation component organizes the system and the plurality of subsystems and components into a hierarchical representation. An interactive selection component provides a plurality of options for analyzing the hierarchical representation. A reliability analysis component, responsive to the hierarchical representation component and the interactive selection component, performs a reliability analysis at any level of the hierarchical representation.

In a second embodiment of this disclosure, there is an interactive graphics-based tool, method and computer readable medium that stores instructions for instructing a computer system, to perform a reliability analysis on a system having a plurality of subsystems and a plurality of components within each subsystem. In this embodiment, a hierarchical representation component organizes the system and the plurality of subsystems and components into a hierarchical representation. An interactive selection component provides a plurality of options for analyzing the hierarchical representation. A reliability analysis component, responsive to the hierarchical representation component and the interactive selection component, performs a reliability analysis at any level of the hierarchical representation. A visualization component provides a visualization of the reliability analysis.

In another embodiment, there is a system, method and computer readable medium that stores instructions for instructing a computer system, to perform a reliability analysis on a system having a plurality of subsystems and a plurality of components within each subsystem. In this embodiment, a data repository contains a plurality of service data for the system. An interactive data preprocessor preprocesses the plurality of service data in accordance with a user specified reliability analysis selection. An interactive graphics-based tool performs the user specified reliability analysis on the system in accordance with the plurality of service data. The interactive graphics-based tool comprises a hierarchical representation component that organizes the system and the plurality of subsystems and components into a hierarchical representation. An interactive selection component provides a plurality of options for analyzing the hierarchical representation. A statistical analysis component, responsive to the hierarchical representation component and the interactive selection component, performs a statistical analysis at any level of the hierarchical representation. A visualization component provides a visualization of the statistical analysis in a graphical framework.

In another embodiment, there is a system that performs a reliability analysis on a system having a plurality of subsystems and a plurality of components within each subsystem. In this embodiment, a data repository contains a plurality of service data for the system. An interactive graphics-based tool performs a statistical analysis on the system in accordance with the plurality of service data. The interactive graphics-based tool comprises a hierarchical representation component that organizes the system and the plurality of subsystems and components into a hierarchical representation. An interactive selection component provides a plurality of options for analyzing the hierarchical representation. A statistical analysis component, responsive to the hierarchical representation component and the interactive selection component, performs a statistical analysis at any level of the hierarchical representation. A visualization component provides a visualization of the statistical analysis in a graphical framework. A computing unit is configured to serve the data repository and the interactive graphics-based tool.

In a fifth embodiment, there is a method and computer readable medium that stores instructions for instructing a computer system, to enable a user to perform a reliability analysis on a system having a plurality of subsystems and a plurality of components within each subsystem. In this embodiment, a user is prompted to organize the system and the plurality of subsystems and components into a hierarchical representation. Also, the user is prompted to select from a plurality of analyzing options. In response to the user selection, a reliability analysis may be performed at any level of the hierarchical representation. A visualization of the reliability analysis is then provided to the user.

### BRIEF DESCRIPTION OF THE DRAWINGS

FIG. 1 shows a schematic diagram of a general-purpose computer system in which an interactive graphics-based reliability analysis tool for visualizing and performing a reliability analysis operates;

FIG. 2 shows a top-level component architecture diagram of the interactive graphics-based reliability analysis tool that operates on the computer system shown in FIG. 1;

FIG. 3 shows an example of data structure elements that the hierarchical representation component of the interactive graphics-based reliability analysis tool shown in FIG. 2 uses to construct a hierarchical representation;

FIG. 4 shows an analysis architecture flow diagram performed by the interactive graphics-based reliability analysis tool shown in FIG. 2;

FIG. 5 shows an example of a hierarchical representation of an aircraft made with the interactive graphics-based reliability analysis tool shown in FIG. 2;

FIGS. 6a-6d show examples of selection options made available to a user of the interactive graphics-based reliability analysis tool shown in FIG. 2;

FIG. 7 shows a flow chart describing the main routine performed by the analysis architecture flow diagram shown in FIG. 4;

FIG. 8 shows a flow chart describing the operations involved in building a tree in accordance with FIG. 7;

FIG. 9 shows an example of a tree structure constructed from the flow chart shown in FIG. 8;

FIGS. 10a-10d show flow charts describing the processing operations associated with FIG. 7;

FIGS. 11a-11b show flow charts describing the processing operations associated with the Weibull and Lognormal analysis set forth in FIG. 10c;

FIG. 12 shows a flow chart describing the processing operations associated with the MLE analysis set forth in FIG. 11a;

FIGS. 13a-13b shows a flow chart describing the processing operations associated with the Likelihood Contour analysis set forth in FIG. 11a;

FIG. 14 shows a flow chart describing the processing operations associated with the Forecasting analysis set forth in FIG. 10c;

FIG. 15 shows a flow chart describing the processing operations associated with the Simulated Failure analysis set forth in FIG. 14;

FIG. 16 shows a flow chart describing the processing operations associated with the SDM analysis set forth in FIG. 10d;

FIG. 17 shows a flow chart describing the processing operations associated with Reliability analysis set forth in FIG. 10d;

FIGS. 18a-18e show examples of various analyses presented to a user of the interactive graphics-based reliability analysis tool shown in FIG. 2;

FIG. 19 shows an architectural diagram of a system for implementing the interactive graphics-based reliability analysis tool on a network shown in FIG. 2;

FIG. 20 shows an architectural diagram of an alternative embodiment for implementing the interactive graphics-based reliability analysis tool shown in FIG. 2; and

FIG. 21 shows an architectural diagram of another alternative embodiment for implementing the interactive graphics-based reliability analysis tool shown in FIG. 2.

### DETAILED DESCRIPTION OF THE INVENTION

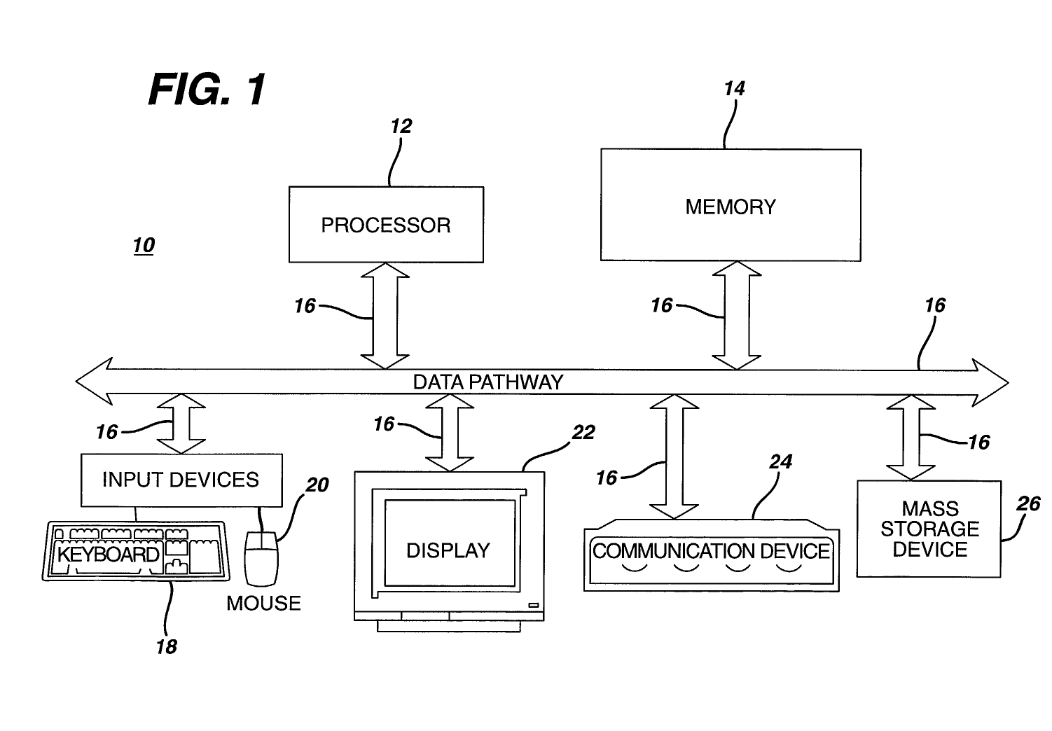

This disclosure describes an interactive graphics-based reliability analysis tool for visualizing reliability of a complex system and performing reliability analysis on the system. The complex system may be a product such as a locomotive, turbine, aircraft engine, automobile, computer, appliance; etc., however, the disclosure is applicable to any system where it is desirable to improve quality and avoid reliability problems. FIG. 1 shows a schematic diagram of a general-purpose computer system 10 in which an interactive graphics-based reliability analysis tool for visualizing and performing a reliability analysis operates. The computer system 10 generally comprises a processor 12, memory 14, input/output devices, and data pathways (e.g., buses) 16 connecting the processor, memory and input/output devices. The processor 12 accepts instructions and data from memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, memory 14 preferably contains an operating system, which executes on the processor 12. The operating system performs basic tasks that include recognizing input, sending output to output devices, keeping track of files and directories and controlling various peripheral devices.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer and speakers. A communication device 24 such as a telephone or cable modem or a network card such as an Ethernet adapter, local area network (LAN) adapter, integrated services digital network (ISDN) adapter, Digital Subscriber Line (DSL) adapter or wireless access card, enables the computer system 10 to access other computers and resources on a network such as a LAN, wireless LAN or wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

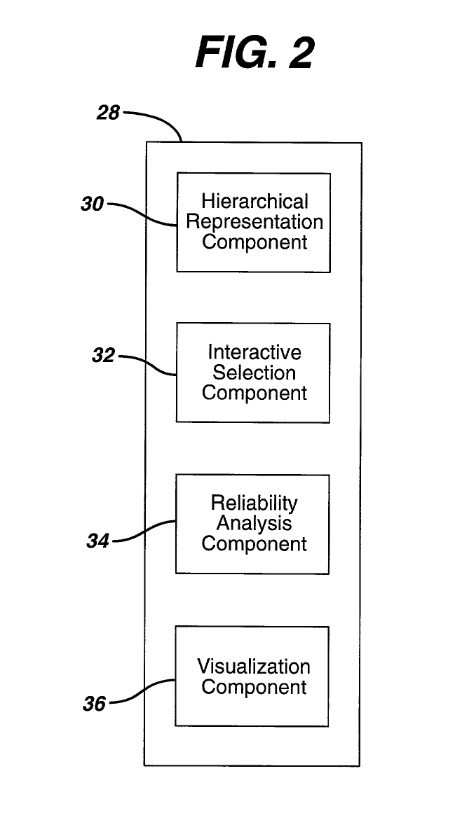

FIG. 2 shows a top-level component architecture diagram of an interactive graphics-based reliability analysis tool 28 that operates on the computer system 10 shown in FIG. 1. Generally, the interactive graphics-based reliability analysis tool 28 allows a user to characterize the reliability of a complex system at all levels (i.e., subsystems and components within each subsystem) from historical service data. The user can then use the reliability characterization to predict the rate at which a system (i.e., subsystem and/or components) will fail, determine the cost of the system over its entire life span, forecast risk for long term service agreement pricing and monitoring of the system. One of ordinary skill in the art will recognize that the reliability characterization can be used to perform additional functions other than the ones listed above such as comparing the fits of various alternative statistical reliability models, identifying which components in the system have the largest impact on system level reliability, etc.

The interactive graphics-based reliability analysis tool 28 comprises a hierarchical representation component 30 that organizes the system and each of its subsystems and respective components into a hierarchical representation. In particular, the hierarchical representation generated by the hierarchical representation component 30 takes the form of a tree structure, wherein the system, subsystems and components are represented in the tree structure by a node.

One method for creating such a tree structure is to use as input a data set in which each record provides the failure time along with the values of each of the levels in the hierarchy (e.g., major assembly name, sub assembly name, etc.). For example, input data might consist of the following entries:

| | | | |
|---|---|---|---|
| 14.6 | A | a | U |
| 20.5 | A | a | V |
| 30.2 | A | b | W |
| 15.3 | B | c | X |
| 20.2 | B | d | Y |
| 15.6 | B | d | Y |
| 2.3 | B | d | Z |

The first column represents failure times, and the remaining three columns give the values at each of three levels (i.e., 1, 2, 3). Level 1 takes on the values “A” or “B”, level 2 takes on the values of “a”, “b”, “c”, or “d”, and level 3 takes on the values of “U”, “V”, “W”, “X”, “Y”, or “Z”.

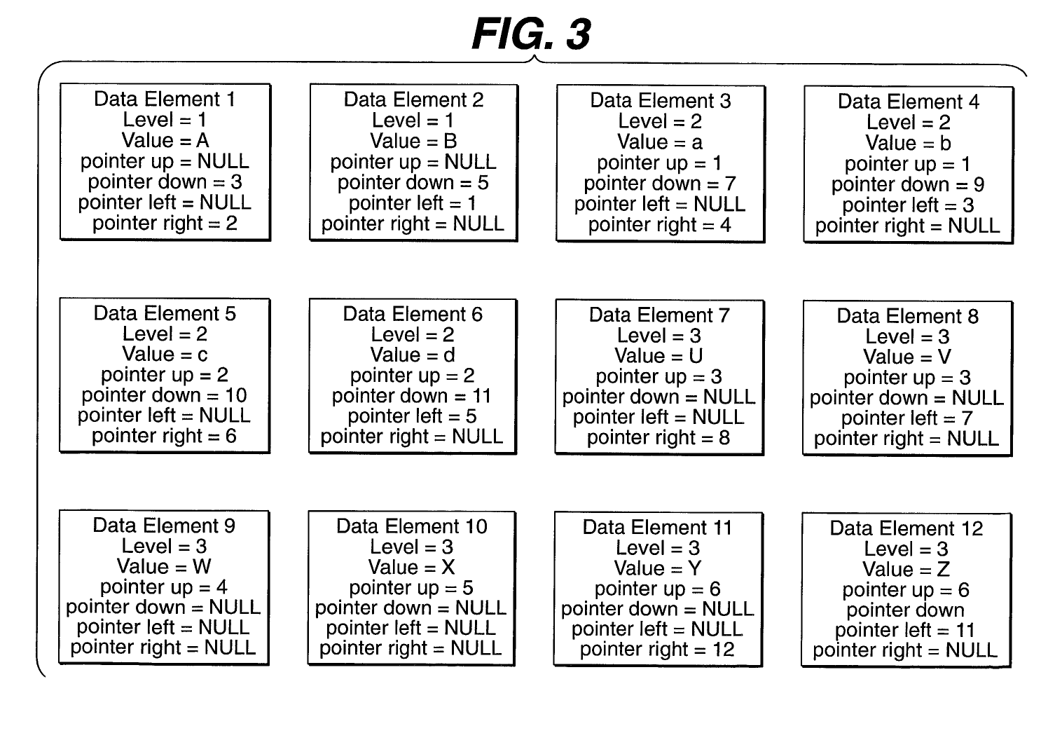

The hierarchy of the tree structure is constructed from this input data by creating a data element for each unique value at each level. Each data element consists of the data element number, the level number, the value, and pointers to the other data structure elements that are located in the hierarchy above this element, to the right of this element, to the left of this element, and to the first node below this element. For example, with the above input data set, the data structure elements and their pointers would look like FIG. 3, where, for example, “pointer down=3” indicates that the down pointer points to data element number 3. This set of data elements therefore defines the hierarchy and enables the user to navigate throughout it.

The interactive graphics-based reliability analysis tool 28 shown in FIG. 2 also comprises an interactive selection component 32 that provides a plurality of options for interactively analyzing the hierarchical representation. For example, the plurality of options provided by the interactive selection component 32 comprises options such as moving about the hierarchical representation (i.e., from one node to another node), selecting a node, defining a group of nodes or invoking any of a number of reliability analysis modules relevant to that particular point in the hierarchy. One of ordinary skill in the art will recognize that there are a variety of other options that may be provided by the interactive selection component 32 such as the ability to “prune the tree” (i.e., eliminate nodes in the hierarchy).

A reliability analysis component 34, responsive to the hierarchical representation component 30 and the interactive selection component 32, performs a reliability analysis at any level of the hierarchical representation (i.e., system, subsystem, component) as desired. A variety of different types of reliability analyses may be performed at each node or groups of nodes as selected by a user. For example, an illustrative but non-exhaustive list of reliability analyses that the reliability analysis component 34 may perform include statistical analyses, reliability prediction, life cycle cost analysis, maintenance projections, and inventory forecasting. Other types of reliability analyses may include comparing the fits of various alternative statistical reliability models, identifying which components in the system have the largest impact on system level reliability, etc.

A visualization component 36 provides a visualization of the reliability analysis performed on any of the nodes to the user. In particular, the visualization component 36 provides the user with a graphical framework in which the various reliability analyses can be performed. The results (e.g., charts, graphs, plots, movie mode displays) of the reliability analyses are presented to the user within this graphical framework. Below is a more detailed discussion of the processing that is involved in the visualization of the reliability of a system.

The interactive graphics-based reliability analysis tool 28 is not limited to the hierarchical representation component 30, interactive selection component 32, reliability analysis component 34 and visualization component 36. One of ordinary skill in the art will recognize that the interactive graphics-based reliability analysis tool 28 may have other components. For example, the interactive graphics-based reliability analysis tool 28 could also include a module for comparing the fits of various alternative statistical reliability models, a module for identifying which components in the system have the largest impact on system level reliability, etc.

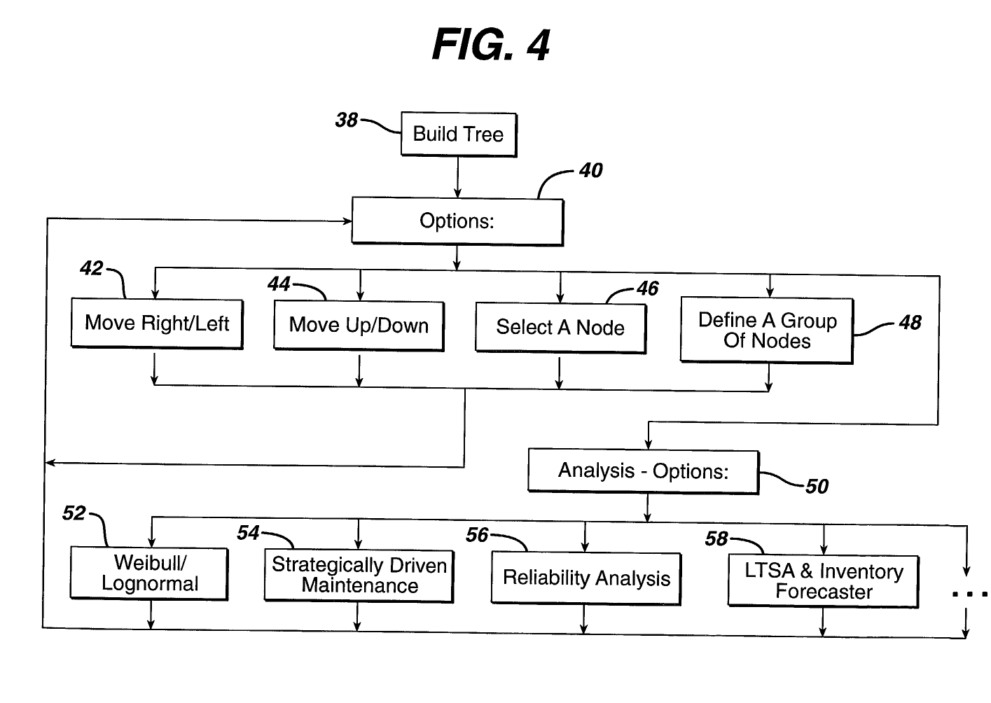

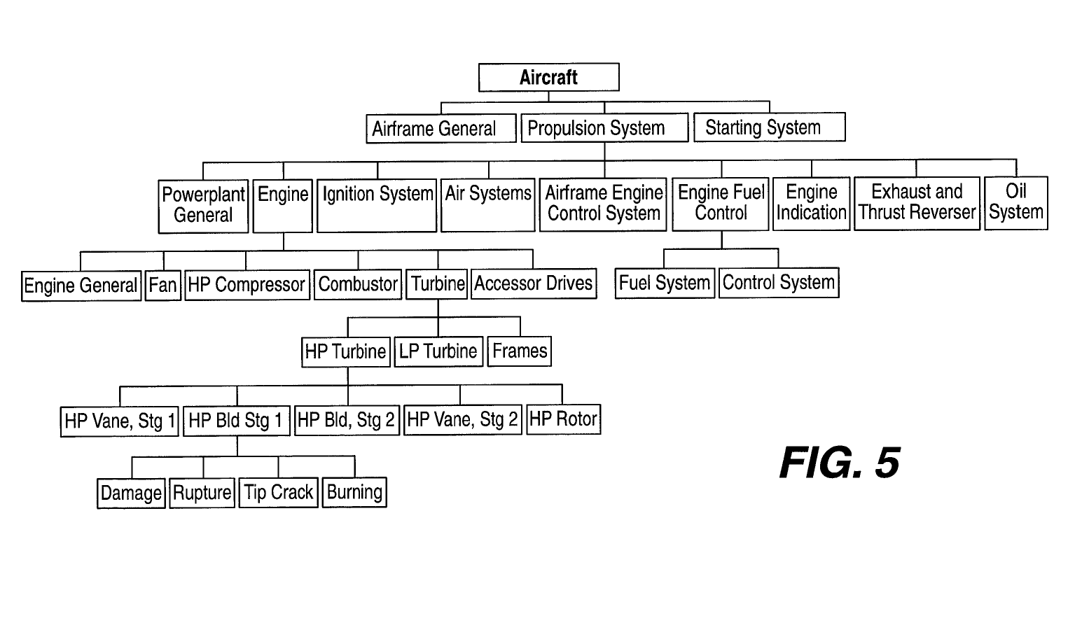

FIG. 4 shows an analysis architecture flow diagram performed by the interactive graphics-based reliability analysis tool 28 shown in FIG. 2. In the analysis architecture flow diagram, a user uses the hierarchical representation component 30 to build a tree structure of a particular system and each of its subsystems and respective components at 38. FIG. 5 shows an example of a hierarchical representation of an aircraft. In this example, the aircraft is shown with three subsystems; an airframe, a propulsion system and a starting system. The hierarchical representation component 30 enables a user to model each subsystem into additional systems and their respective components. For ease of illustration, FIG. 5 only provides a representation of the propulsion system. In this example, the propulsion system has a power plant system, an engine, an ignition system, an air system, an airframe engine control system, an engine fuel control system, an engine indication system, an exhaust and thrust reverser system and an oil system. As shown in FIG. 5, each of these systems has their own components. For example, the engine is divided into a general section, a fan, a HP compressor, a combustor, a turbine and accessor drivers. Furthermore, each of these components has their own components. For example, see the components listed for the turbine. One of ordinary skill in the art will recognize that this hierarchical representation of the aircraft is an example and is not illustrative of all the ways of representing an aircraft. Furthermore, the interactive graphics-based reliability analysis tool 28 is not limited to an aircraft and can be used to analyze any complex system where it is desirable to improve quality and avoid reliability problems.

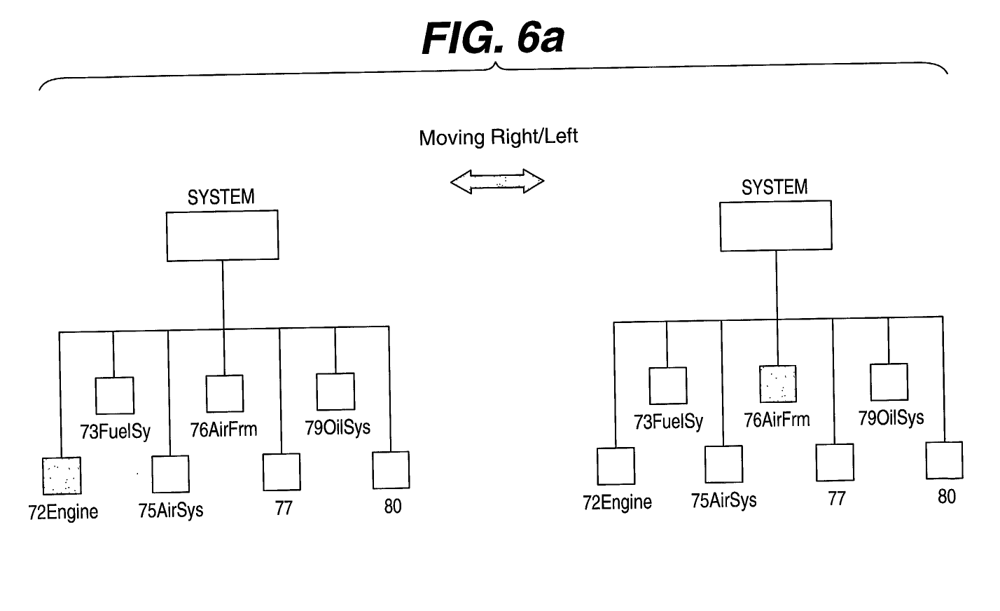

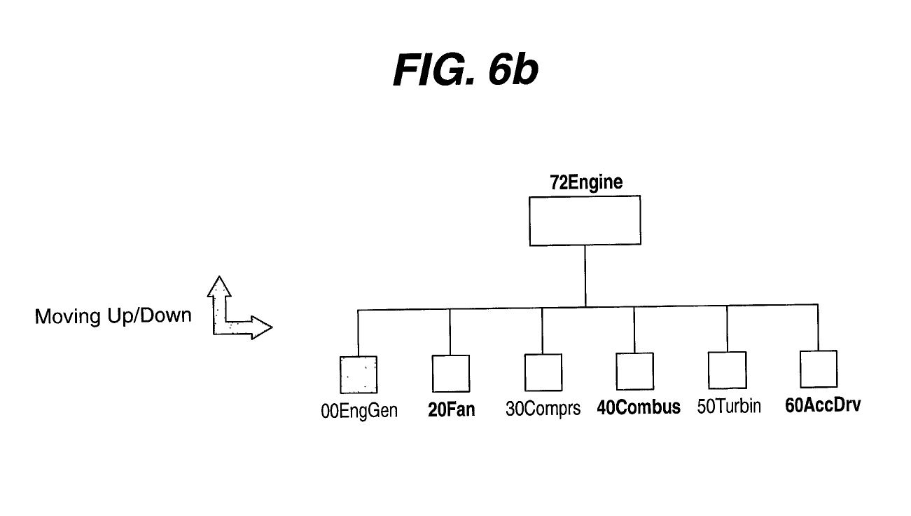

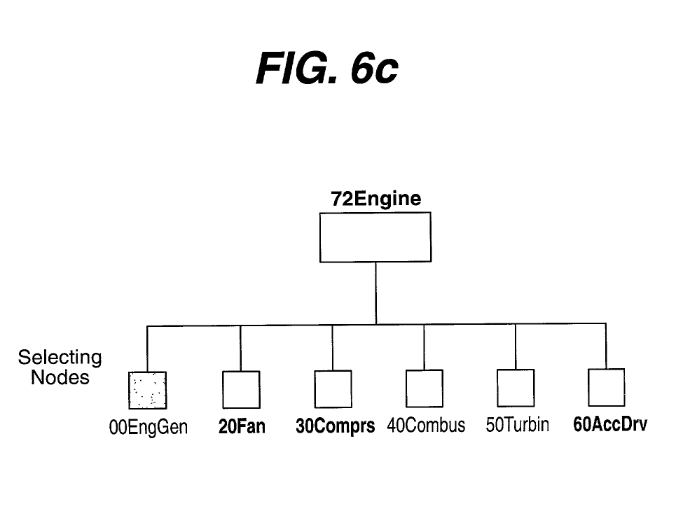

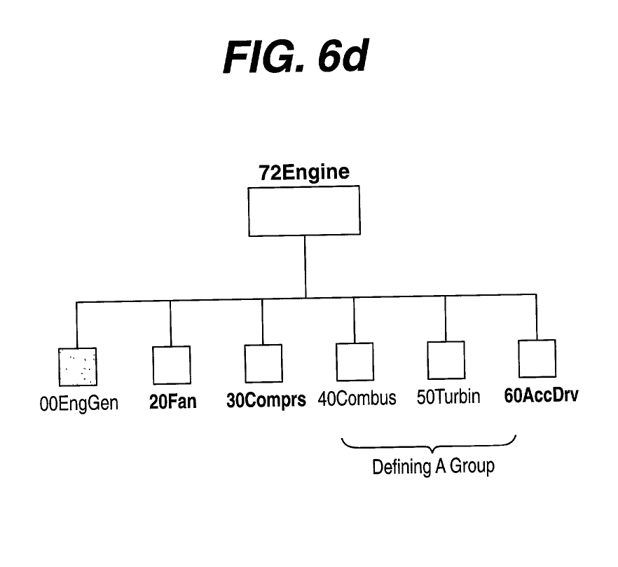

Referring to FIG. 4, after the user has built a tree structure representing the system, then he or she has a plurality of options made available at 40 by the interactive selection component. These options enable the user to analyze the system at any level of the hierarchical representation. These options may include moving about the hierarchical representation (i.e., from one node to another node) 42 and 44, selecting a node 46 and defining a group of nodes 48. FIGS. 6a-6d show examples of these options with a hierarchical representation. In particular, FIG. 6a shows the moving from either right or left within a representation. FIG. 6b shows moving up and down within a representation. FIG. 6c shows the selecting of a node within a representation. FIG. 6d shows the defining of a group of nodes within a representation.

Referring again to FIG. 4, after the user has selected one of the above options 42-48, then at least one of several analyses may be selected at 50 and performed at any level of the hierarchical representation. An illustrative but non-exhaustive list of the analyses that a user may select includes a Weibull or Lognormal analysis 52, a strategically driven maintenance analysis 54, a reliability analysis 56 and a long term service agreement and inventory forecast analysis 58. As mentioned above, this disclosure is not limited to these types of analyses. Other types of analyses may include comparing the fits of various alternative statistical reliability models, identifying which components in the system have the largest impact on system level reliability, etc.

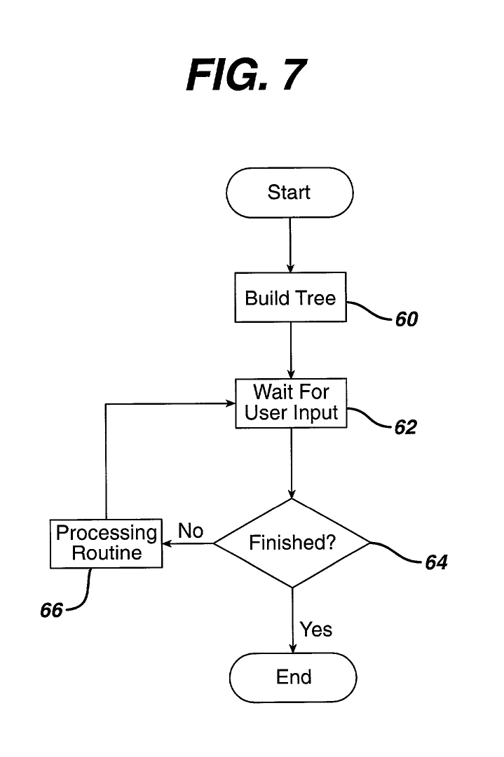

FIG. 7 shows a flow chart describing the main routine performed by the analysis architecture flow diagram shown in FIG. 4. At 60, the main routine begins by building the tree structure. The interactive graphics-based reliability analysis tool waits for user input at 62. As mentioned above, the user input could comprise items such as but not including moving right or left, moving up or down, selecting a node, defining a group of nodes or performing an analysis (e.g., Weibull, Lognormal, Strategically Driven Maintenance, reliability analysis, forecasting, etc.). Once it is determined at 64 that the user is finished the routine ends. Otherwise, the user selection is processed at 66 and continues processing until the user is finished.

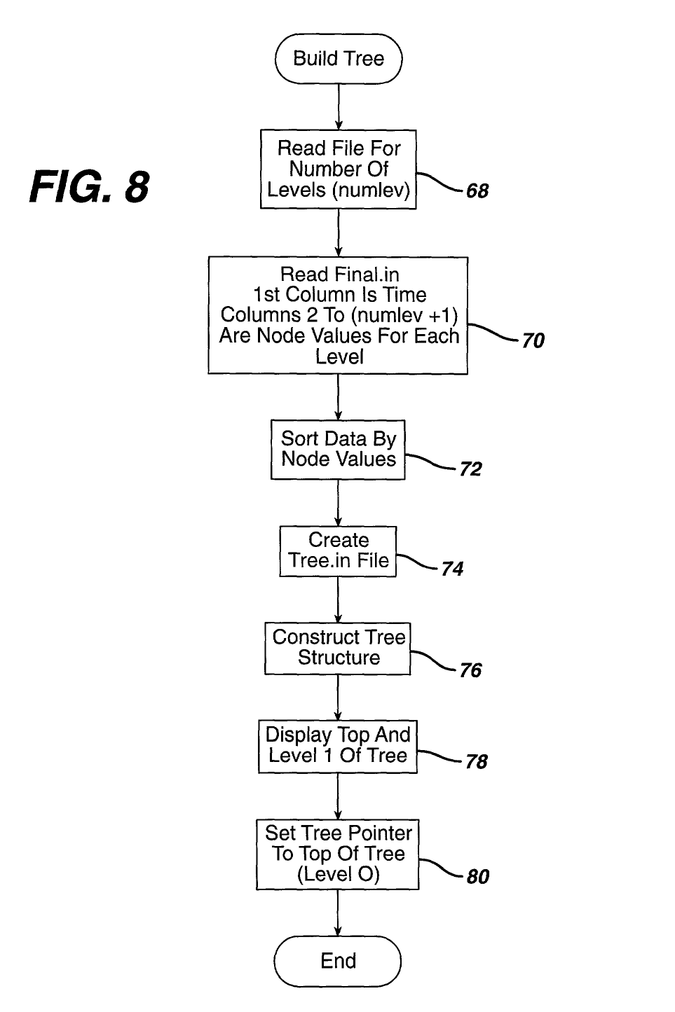

FIG. 8 shows a flow chart describing the operations involved in building a tree in accordance with FIG. 7. First, a file is read at 68 that contains certain parameters that will be used by the program. These parameters may include, but are not limited to, the number of levels in the tree structure (numlev), the width of the confidence bounds displayed on various graphs (e.g., 0.90 for 90% confidence bounds, 0.95 for 95% confidence bounds, etc), and whether the analysis is to be done utilizing a competing or non-competing failure mode model. Another file (final.in), contains the input data as was described by example earlier is read at 70. The first column in this file is representative of time and the remaining columns are representative of node values for each level. The last column is designated numlev+1. At 72, the data are sorted by the node values. The interactive graphics-based reliability analysis tool creates another file (e.g., tree.in) for storing this data at 74. In this file, there is one record for each unique set of node values in the final.in file. The last two columns give corresponding beginning and ending record numbers in the final.in file. Both the initial file read at 68 and the final.in file read at 70 may be created directly by the user, or these files may be created automatically through a preprocessor front-end which contains various user input screens which allows the user to specify the input database and aids the user in constructing the required columns in final.in.

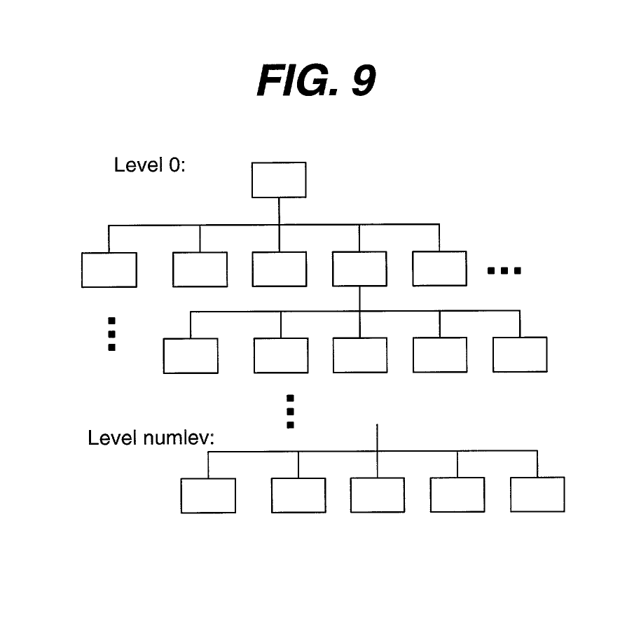

The interactive graphics-based reliability analysis tool constructs the tree structure from the tree.in file at 76. For each node in the tree, the interactive graphics-based reliability analysis tool constructs a tree structure with elements that comprise a node name, level number (0, 1, . . . , numlev), beginning record in final.in, ending record in final.in, pointer to node at left (or NULL), pointer to node at right (or NULL), pointer to node above (or NULL) and pointer to the left most node at the next level (or NULL). FIG. 9 shows an example of a tree structure constructed from the flow chart shown in FIG. 8. Referring back to FIG. 8, after the tree structure has been constructed, it is displayed to the user at 78. In one embodiment, the interactive graphics-based reliability analysis tool displays only one level with its parent node displayed at any given time. Those experienced in the art will recognize that other well know methods can be used to display the tree, including, for example displaying the tree sideways. To distinguish one node from the others, the interactive graphics-based reliability analysis tool can highlight any of the displayed nodes. In the suggested embodiment where only one level and its parent node are displayed, if the parent node is selected, then one can say that the “current node is at parent”, otherwise the “current node is at level”. Next, the interactive graphics-based reliability analysis tool sets the tree pointer to the top of the tree (i.e., level 0) at 80.

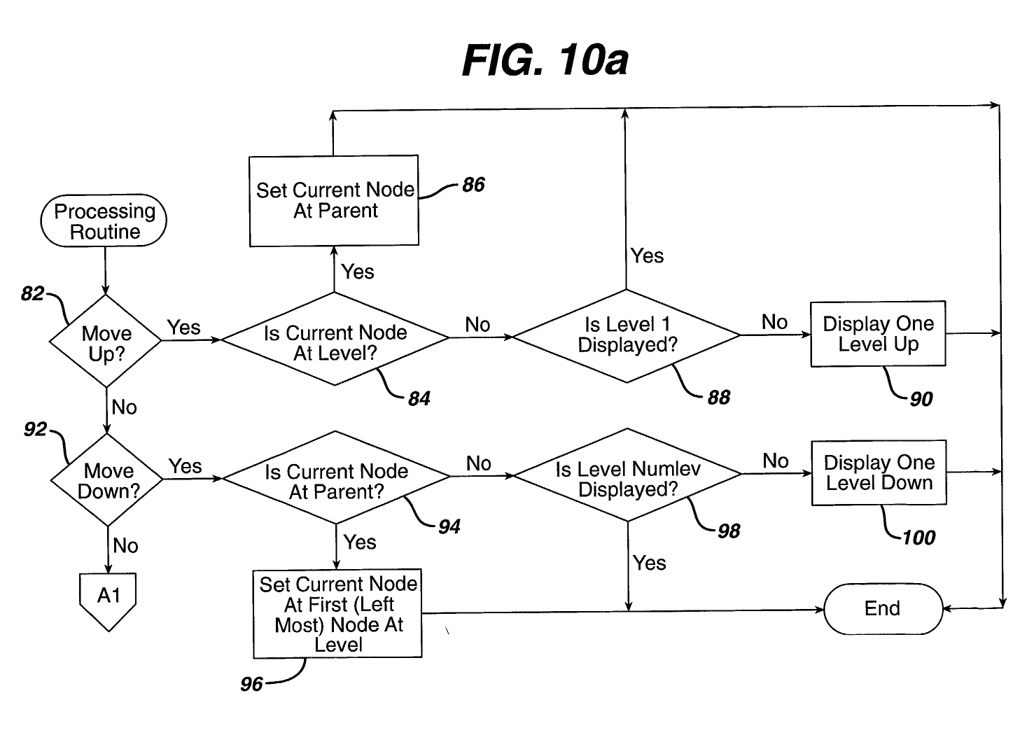

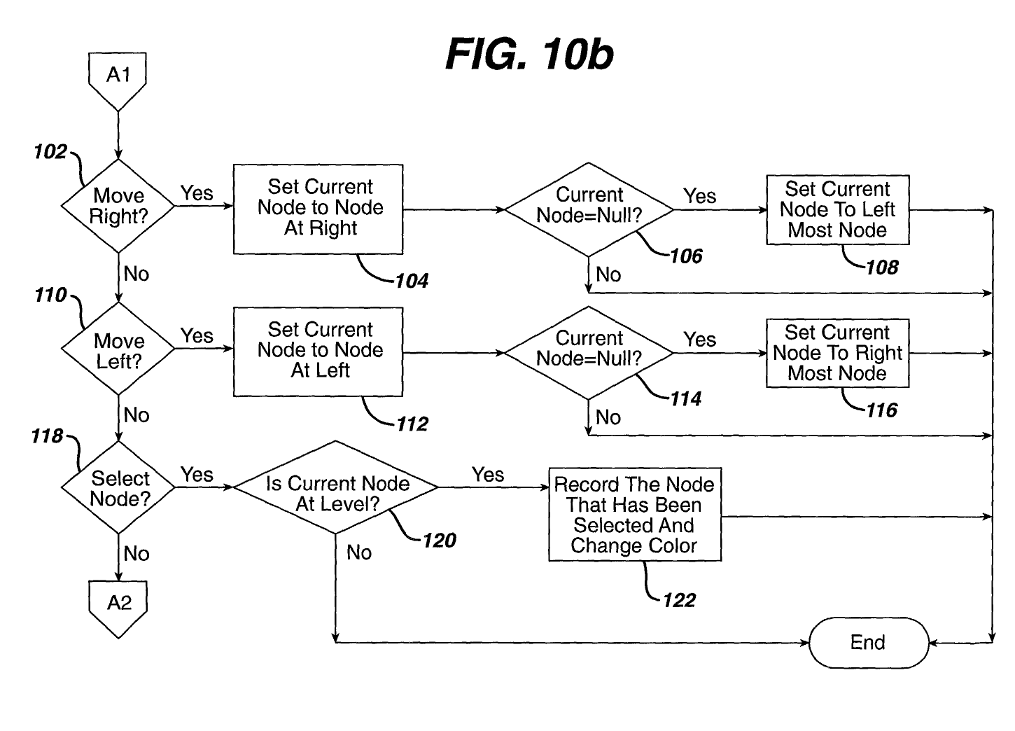

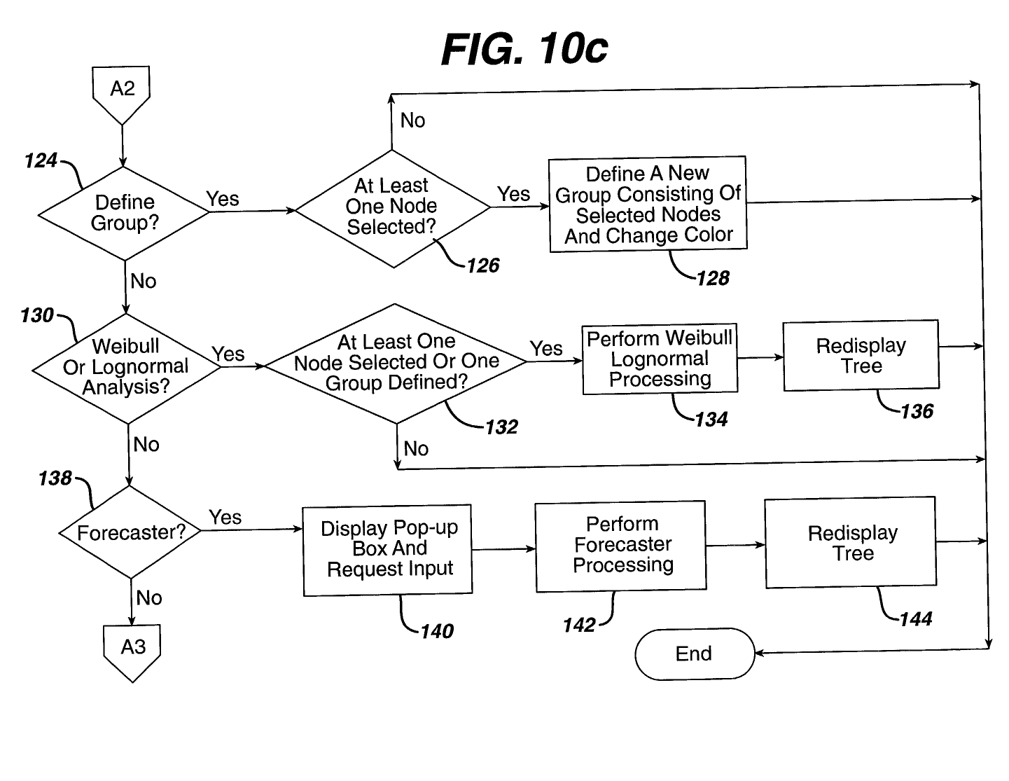

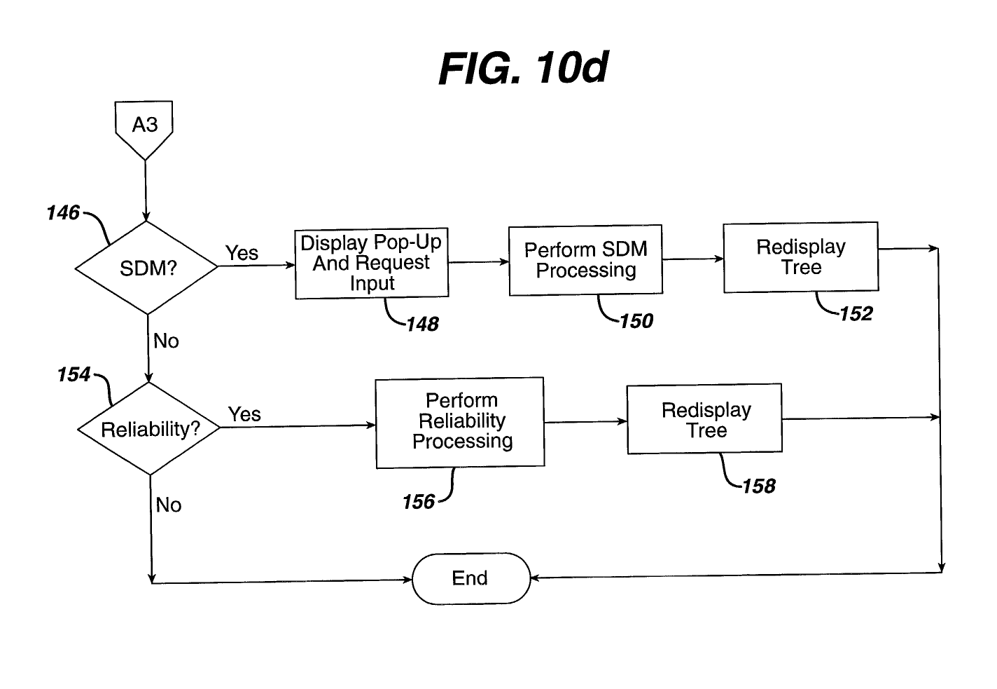

FIGS. 10a-10d show flow charts describing the processing operations associated with FIG. 7. In FIG. 10a, the processing begins at 82, where a determination is made with respect to the user input. In particular, the interactive graphics-based reliability analysis tool determines whether the user wants to move up within the tree structure. If the user does want to move up, then the next determination made at 84 is whether the current node is at level. If the current node is at level then the current node is set as the parent at 86. The processing ends and waits for further input from the user. Alternatively, if the current node is not at level, then a determination of whether level 1 is displayed is made at 88. If level 1 is displayed then the processing ends and waits for further input from the user. If level 1 is not displayed, then one level up in the tree structure is displayed at 90.

If the user does not want to move up as determined at 82, then a determination of whether the user wants to move down is made at 92. If the user does want to move down, then the next determination made at 94 is whether the current node is at parent. If the current node is at parent, then the current node is set at the first (left most) node at level at 96. The processing ends and there is a wait for further input from the user. Alternatively, if the current node is not at parent, then a determination of whether the lowest level in the graph (level numlev) is displayed is made at 98. If level numlev is displayed then the processing ends and there is a wait for further input from the user. If level numlev is not displayed, then the one level down in the tree structure is displayed at 100.

FIG. 10b shows further processing operations. In particular, if the user does not want to move down as determined at 92, then a determination of whether the user wants to move right is made at 102. If the user does want to move right, then the current node is set to the node at the right at 104. If there are no more nodes to the right, then the current node at this point is deemed equal to NULL. Next, a determination is made at 106 to determine whether the current node equals NULL. If the current node equals NULL, then the current node is set to the left most node at 108. The processing then ends and there is a wait for further input from the user. Alternatively, if the current node does not equal NULL, then processing ends and there is a wait for further input from the user.

If the user does not want to move right as determined at 102, then a determination of whether the user wants to move left is made at 110. If the user does want to move left, then the current node is set to the node at the left at 112. If there are no more nodes to the left, then the current node at this point is deemed equal to NULL. Next, a determination is made at 114 to determine whether the current node equals NULL. If the current node equals NULL, then the current node is set to the right most node at 116. The processing then ends and there is a wait for further input from the user. Alternatively, if the current node does not equal NULL, then processing ends and there is a wait for further input from the user.

If the user does not want to move left as determined at 110, then a determination of whether the user wants to select a node is made at 118. If the user does want to select a node, then a determination of whether the current node is at level is made 120. If the current node is at level, then that node is recorded and is highlighted at 122. The processing then ends and there is a wait for further input from the user. Alternatively, if the current node is not at level, then processing ends and there is a wait for further input from the user.

FIG. 10c shows further processing operations. In particular, if the user does not want to select a node as determined at 118, then a determination of whether the user wants to define a group is made at 124. If the user does want to define a group, then a determination of whether at least one node has been selected is made at 126. If at least one node has been selected, then a new group comprising the selected nodes is defined at 128 and that group is highlighted. The processing then ends and there is a wait for further input from the user. Alternatively, if the user has not selected at least one node, then processing ends and there is a wait for further input from the user.

If the user does not want to define a group as determined at 124, then a determination of whether the user wants to perform a Weibull or Lognormal analysis is made at 130. If the user does want to perform a Weibull or Lognormal analysis, then a determination of whether at least one node has been selected or one group has been defined is made 132. If at least one node has been selected or one group has been defined, then a Weibull or Lognormal analysis is performed at 134. After the analysis, the interactive graphics-based reliability analysis tool then redisplays the tree at 136 and the processing then ends and there is a wait for further input from the user.

If the user does not want to perform a Weibull or Lognormal analysis as determined at 130, then a determination of whether the user wants to perform a forecasting analysis is made at 138. If the user does want to perform a forecasting analysis, then the interactive graphics-based reliability analysis tool displays a pop-up box and request input from the user at 140. An illustrative but non-exhaustive list of input that a user can provide may comprise information such as number of time intervals to forecast, the size of each interval, the date at which to begin the forecast, etc. The interactive graphics-based reliability analysis tool then performs the forecasting analysis at 142. After the analysis, the interactive graphics-based reliability analysis tool then redisplays the tree at 144 and the processing ends and there is a wait for further input from the user.

FIG. 10d shows further processing operations. In particular, if the user does not want to perform a forecasting analysis as determined at 138, then a determination of whether the user wants to perform a strategically driven maintenance (SDM) analysis is made at 146. Strategically Driven Maintenance is a procedure by which statistical information is used to determine the optimal time to replace a part before it fails in order to prevent an unexpected failure in the field. If the user does want to perform a Strategically Driven Maintenance analysis, then the interactive graphics-based reliability analysis tool displays a pop-up box and request input from the user at 148. An illustrative but non-exhaustive list of input that a user can provide may comprise information such as cost of the part, cost associated with an unexpected failure, length of time between routine maintenance shop visits, etc. The interactive graphics-based reliability analysis tool then performs the Strategically Driven Maintenance analysis at 150. After the analysis, the interactive graphics-based reliability analysis tool then redisplays the tree at 152 and the processing ends and there is a wait for further input from the user.

If the user does not want to perform the Strategically Driven Maintenance analysis as determined at 146, then a determination of whether the user wants to perform a reliability analysis is made at 154. If the user does want to perform a reliability analysis, then the interactive graphics-based reliability analysis tool performs the analysis at 156. After the analysis, the interactive graphics-based reliability analysis tool then redisplays the tree at 158 and the processing ends and there is a wait for further input from the user.

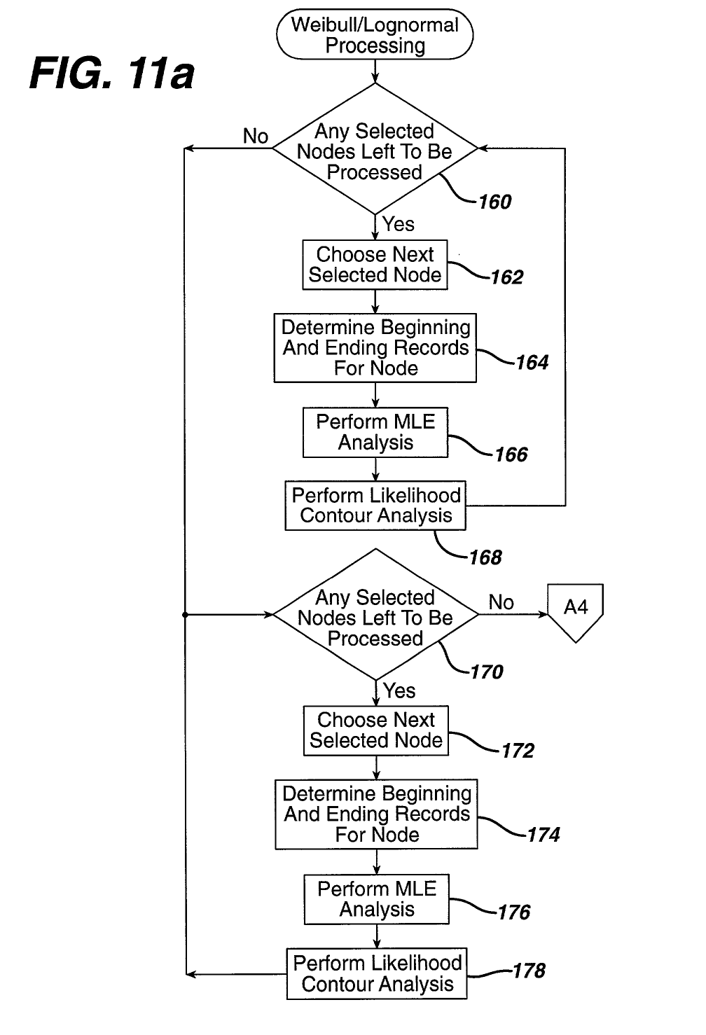

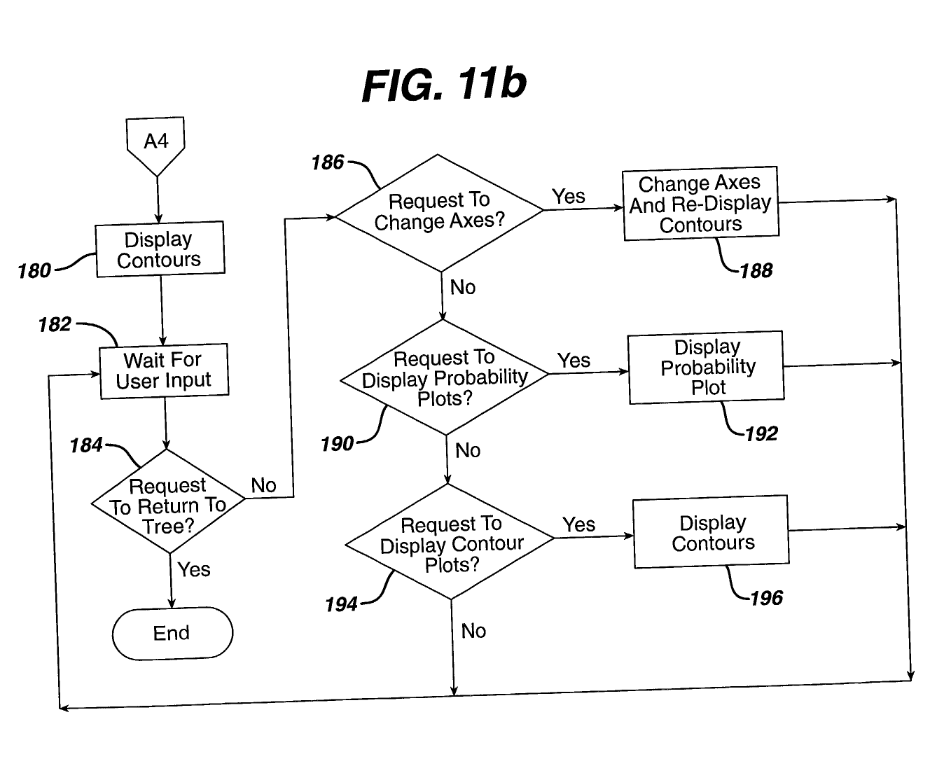

FIGS. 11a-11b show flow charts describing the processing operations associated with the Weibull and Lognormal analysis set forth in FIG. 10c. The Weibull/Lognormal processing operations begin at block 160 where a determination is made regarding selected nodes. If there are still selected nodes left for processing, then the next step is to choose the next selected node at 162. Next, the interactive graphics-based reliability analysis tool determines the beginning and ending records for the selected node at 164. The interactive graphics-based reliability analysis tool then estimates the parameters through the well known statistical technique of Maximum Likelihood Estimation (MLE) analysis at 166. After performing the MLE analysis, the interactive graphics-based reliability analysis tool performs a Likelihood Contour analysis at 168. Blocks 160-168 are repeated until there are no more selected nodes left for processing. After deciding that there are no more selected nodes left for processing, then the interactive graphics-based reliability analysis tool determines whether there are any selected groups left for processing at 170. If there are still selected groups left for processing, then the next step is to choose the next selected group at 172. Next, the interactive graphics-based reliability analysis tool determines the beginning and ending records for all nodes in the group at 174. The interactive graphics-based reliability analysis tool then performs a MLE analysis at 176. After performing the MLE analysis, the interactive graphics-based reliability analysis tool performs a Likelihood Contour analysis at 178. Blocks 170-178 are repeated until there are no more selected groups left for processing.

After deciding that there are no more selected groups left for processing, then the Weibull/Lognormal processing operations continue in the manner shown in FIG. 11b. In particular, at 180, the interactive graphics-based reliability analysis tool displays contour plots, which show reliability on a two-parameter scale. In the case of Weibull contour plots, this includes the shape parameter (y-axis) and the scale parameter (x-axis). In the case of Lognormal contour plots, this includes the reciprocal of the standard deviation parameter (y-axis) and the mean parameter (x-axis). In either case, the center point of the contour plot is the Maximum Likelihood Estimate (MLE) of the parameters. The interactive graphics-based reliability analysis tool waits for user input at 182 and then determines whether a request to return a tree was made at 184. If there was a request to return the tree, then the Weibull/Lognormal processing operations ends. Otherwise, the Weibull/Lognormal operations continue at 186, where the interactive graphics-based reliability analysis tool determines whether the user made a request to change axes. If the user did make a request to change axes, then the interactive graphics-based reliability analysis tool changes the axes and re-displays the contours at 188. The interactive graphics-based reliability analysis tool then waits for more user input at 182.

If there was not a request to change axes, then the interactive graphics-based reliability analysis tool determines whether the user made a request to display a probability plot at 190. If the user did make a request to display a probability plot, then the interactive graphics-based reliability analysis tool displays the probability plot at 192. The interactive graphics-based reliability analysis tool then waits for more user input at 182. If there was not a request to display a probability plot, then the interactive graphics-based reliability analysis tool determines whether the user made a request to display contour plots at 194. If the user did make a request to display contour plots, then the interactive graphics-based reliability analysis tool displays the contour plots at 196. The interactive graphics-based reliability analysis tool then waits for more user input at 182. This process continues until the user makes a request to return to the tree.

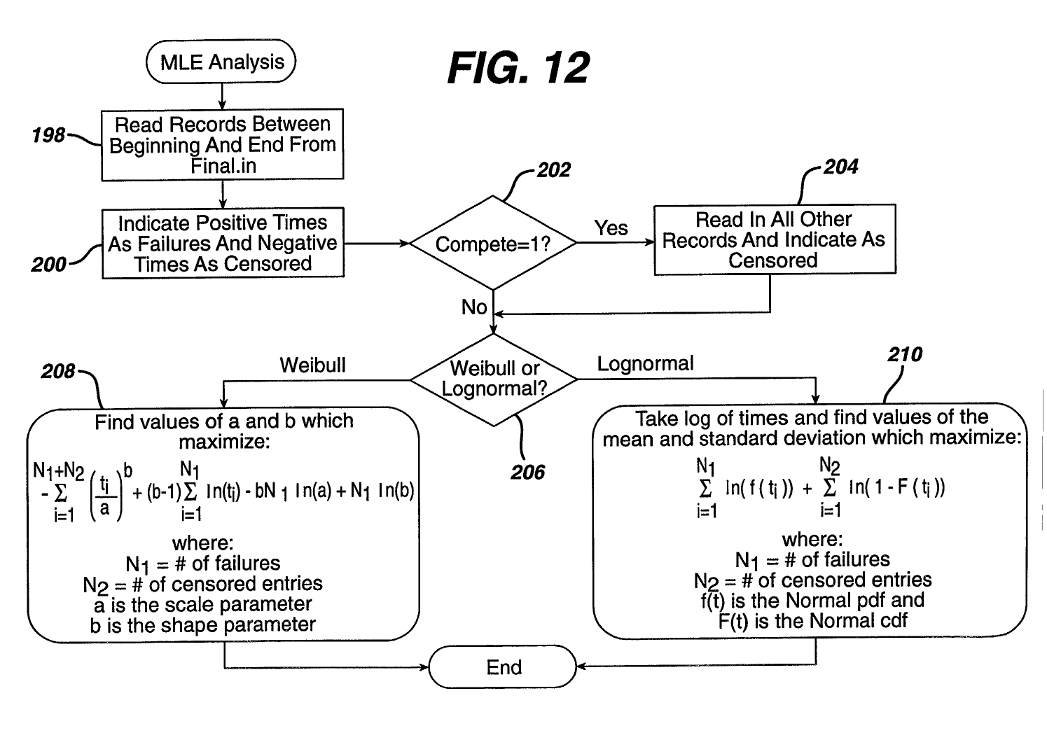

FIG. 12 shows a flow chart describing the processing operations associated with the MLE analysis set forth in FIG. 11a. As described earlier, MLE analysis is used to estimate the parameters of the statistical distribution under consideration. The MLE analysis begins at block 198, where the interactive graphics-based reliability analysis tool reads records between the beginning and end of the final.in file. For these records, the interactive graphics-based reliability analysis tool indicates positive times as failures and negative times as censored (i.e., non-failures) at 200. Next, the interactive graphics-based reliability analysis tool determines at 202 whether compete equals 1, indicating a competing failure mode model. In a competing failure mode model, any failure time in the data set which is not associated with the current node that has been selected is considered to be a suspended (or censored) observation for purposed of estimating the parameters using MLE. If compete does equal 1, then the interactive graphics-based reliability analysis tool reads in all other records and indicates them as censored at 204. Next, the interactive graphics-based reliability analysis tool determines at 206 whether the user has requested a Weibull or Lognormal analysis. If the user requested a Weibull analysis, then the interactive graphics-based reliability analysis tool finds values of a and b at 208 which maximize the following equation:

$$- {\sum }_{i = 1}^{{N}_{1} + {N}_{2}} {( \frac{{t}_{i}}{a} )}^{b} + ( b - 1 ) {\sum }_{i = 1}^{{N}_{1}} ln ( {t}_{i} ) - {bN}_{1} ln ( a ) + {N}_{1} ln ( b )$$

wherein N₁ is the number of failures, N₂ is the number of censored entries, a is the scale parameter and b is the shape parameter. If the user requested a Lognormal analysis, then the interactive graphics-based reliability analysis tool takes a log of times and finds values of the mean and standard deviation at 210 which maximize the following equation:

$${\sum }_{i = 1}^{{N}_{1}} ln ( f ( {t}_{i} ) ) + {\sum }_{i = 1}^{{N}_{2}} ln ( 1 - F ( {t}_{i} ) )$$

wherein N₁ is the number of failures, N₂ is the number of censored entries, f(t) is the Normal pdf and F(t) is the Normal cdf. After the interactive graphics-based reliability analysis tool performs either the Weibull or Lognormal analysis, the MLE analysis is complete.

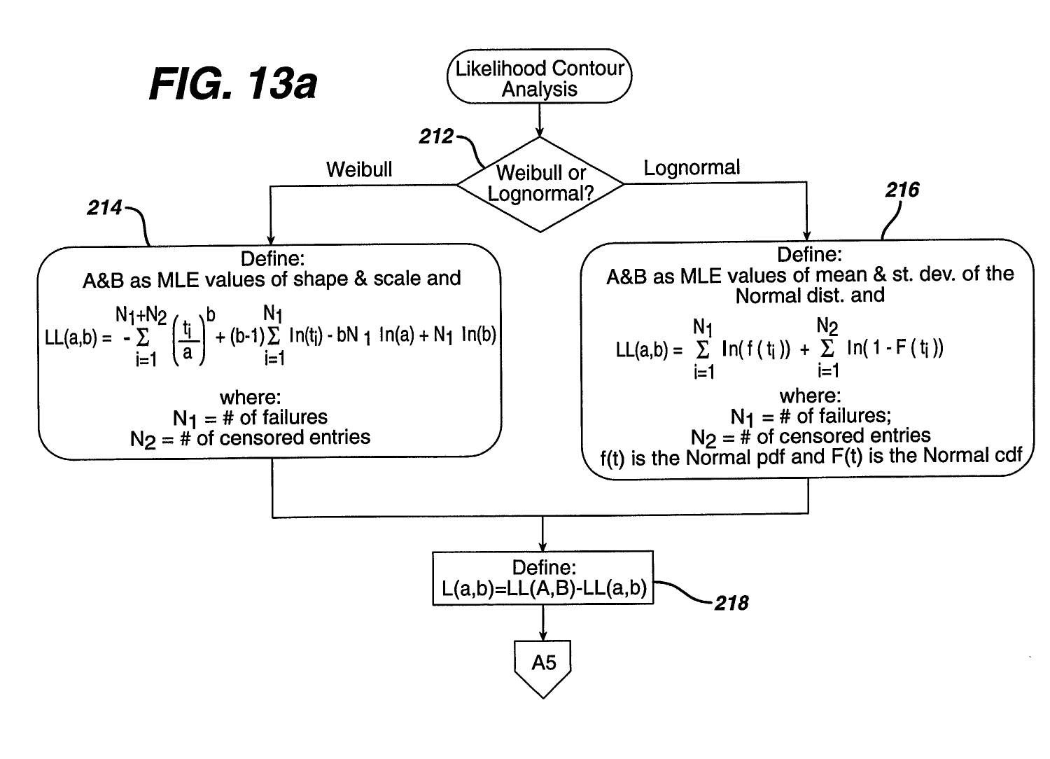

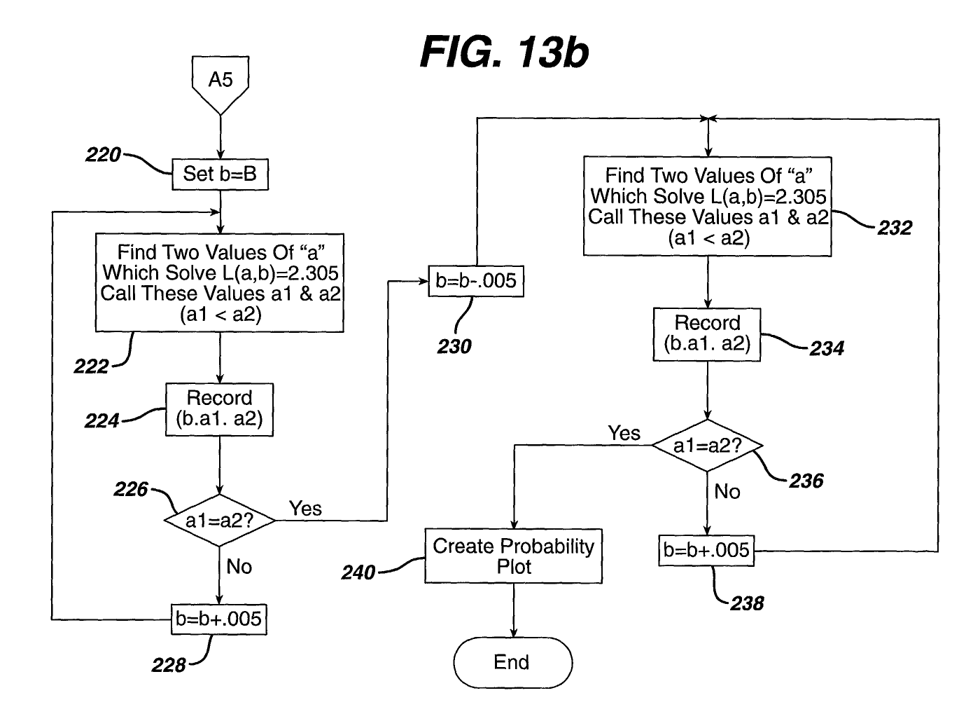

FIGS. 13a-13b show a flow chart describing the processing operations associated with the Likelihood Contour analysis set forth in FIG. 11a. Likelihood Contour analysis provides the user with a visual technique for comparing the reliability of various segments of data. The Likelihood Contour analysis begins at block 212, where the interactive graphics-based reliability analysis tool determines whether the user has requested a Weibull or Lognormal analysis. If the user requested a Weibull analysis, then the interactive graphics-based reliability analysis tool defines A and B as MLE values of shape and scale at 214 and defines the following equation:

$$LL ( a , b ) = - {\sum }_{i = 1}^{{N}_{1} + {N}_{2}} {( \frac{{t}_{i}}{a} )}^{b} + ( b - 1 ) {\sum }_{i = 1}^{{N}_{1}} ln ( {t}_{i} ) - {bN}_{1} ln ( a ) + {N}_{1} ln ( b )$$

wherein LL(a,b) is the name of this functional relationship between a and b, N₁ is the number of failures and N₂ is the number of censored entries. If the user requested a Lognormal analysis, then the interactive graphics-based reliability analysis tool defines A and B as MLE values of the mean and standard deviation of the normal distribution at 216 and defines the following equation:

$$LL ( a , b ) = {\sum }_{i = 1}^{{N}_{1}} ln ( f ( {t}_{i} ) ) + {\sum }_{i = 1}^{{N}_{2}} ln ( 1 - F ( {t}_{i} ) )$$

wherein N₁ is the number of failures, N₂ is the number of censored entries, f(t) is the Normal pdf and F(t) is the Normal cdf. After either step, the interactive graphics-based reliability analysis tool defines L(a,b) at 218 as follows:

L(a,b)=LL(A,B)−LL(a,b)

The Likelihood Contour Analysis continues as shown in FIG. 13b, where the interactive graphics-based reliability analysis tool sets b equal to B at 220. Next, the interactive graphics-based reliability analysis tool finds two values of a at 222 which solve L(a,b)=2.305. These values are called a1 and a2, wherein a1 is less than a2.

The interactive graphics-based reliability analysis tool then sets b equal to B at 224 and determines whether a1 equals a2 at 226. If a1 does not equal a2, then the interactive graphics-based reliability analysis tool sets b equal to b plus 0.005 at 228 and repeats blocks 222-226 until a1 does equal a2. Once a1 does equal a2, then the interactive graphics-based reliability analysis tool sets b equal to b minus 0.005 at 230. Next, the interactive graphics-based reliability analysis tool finds two values of a at 232 which solve L(a,b)=2.305. These values are called a1 and a2, wherein a1 is less than a2. The interactive graphics-based reliability analysis tool then records the values for b, a1 and a2 at 234 and determines whether a1 equals a2 at 236. If a1 does not equal a2, then the interactive graphics-based reliability analysis tool sets b equal to b minus 0.005 at 238 and repeats blocks 232-236 until a1 does equal a2. The interactive graphics-based reliability analysis tool then creates a probability plot of values at 240.

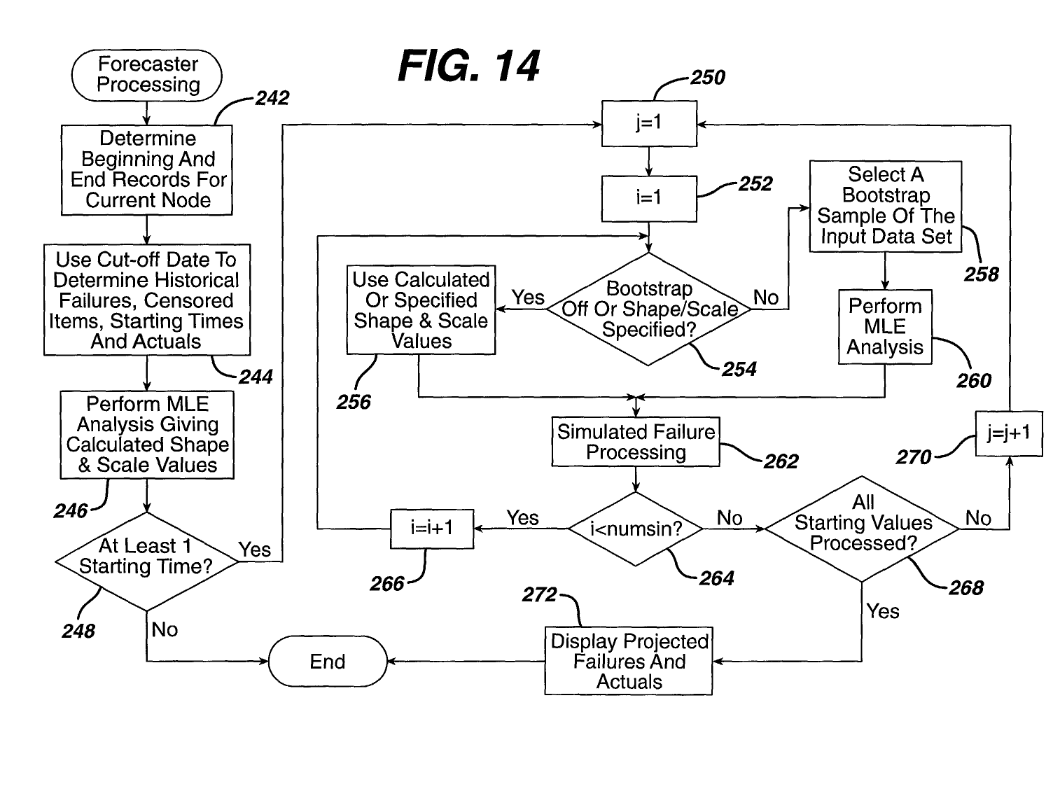

FIG. 14 shows a flow chart describing the processing operations associated with the forecasting analysis set forth in FIG. 10c. The forecasting analysis module is used predict the occurrence of future failures based on the statistical analysis of what has taken place in the past. The forecasting analysis begins at 242, where the interactive graphics-based reliability analysis tool determines the beginning and end records for the current node. The interactive graphics-based reliability analysis tool then uses a predetermined cut-off date to determine historical failures, censored items, starting times (the age of each system at the time of the cut-off date) and actual failures (failures which actually took place after the cut-off date) at 244. By comparing the forecasted failures with the actual failures, the user can determine the accuracy of the forecast. The interactive graphics-based reliability analysis tool then performs the MLE analysis at 246, resulting in the shape and scale values. If there is at least one starting time (at least one system to forecast) as determined at 248, then process continues; otherwise the process ends.

If the forecasting analysis does continue, then the interactive graphics-based reliability analysis tool sets j equal to one at 250 and i equal to one at 252. Next, the interactive graphics-based reliability analysis tool determines whether a user has specified a bootstrap off or shape/scale setting at 254. If the user has specified the shape and scale values, then the interactive graphics-based reliability analysis tool uses these values at 256. Otherwise, the interactive graphics-based reliability analysis tool selects a bootstrap sample from the input data set at 258 and performs a MLE analysis at 260. After performing the operations set forth in blocks 256 or 258 and 260, the interactive graphics-based reliability analysis tool then performs a Simulated Failure processing operation at 262, which is used to generate pseudo-random failure times utilizing a Weibull distribution with specified parameters and age of the system.

The interactive graphics-based reliability analysis tool then determines at 264 whether i is less than numsin, which is the total number of simulations to be performed. If i is less than numsin, then the interactive graphics-based reliability analysis tool sets i equal to i plus one at 266 and repeats blocks 254-264 until i is greater than numsin. If i is greater than numsin, then the interactive graphics-based reliability analysis tool determines at 268 whether all starting values have been processed. If all of the starting values have not been processed, then the interactive graphics-based reliability analysis tool sets j equal to j plus one at 270 and repeats blocks 250-268 until all of the starting values have been processed. At this point, the interactive graphics-based reliability analysis tool then displays the projected failures and actuals at 272.

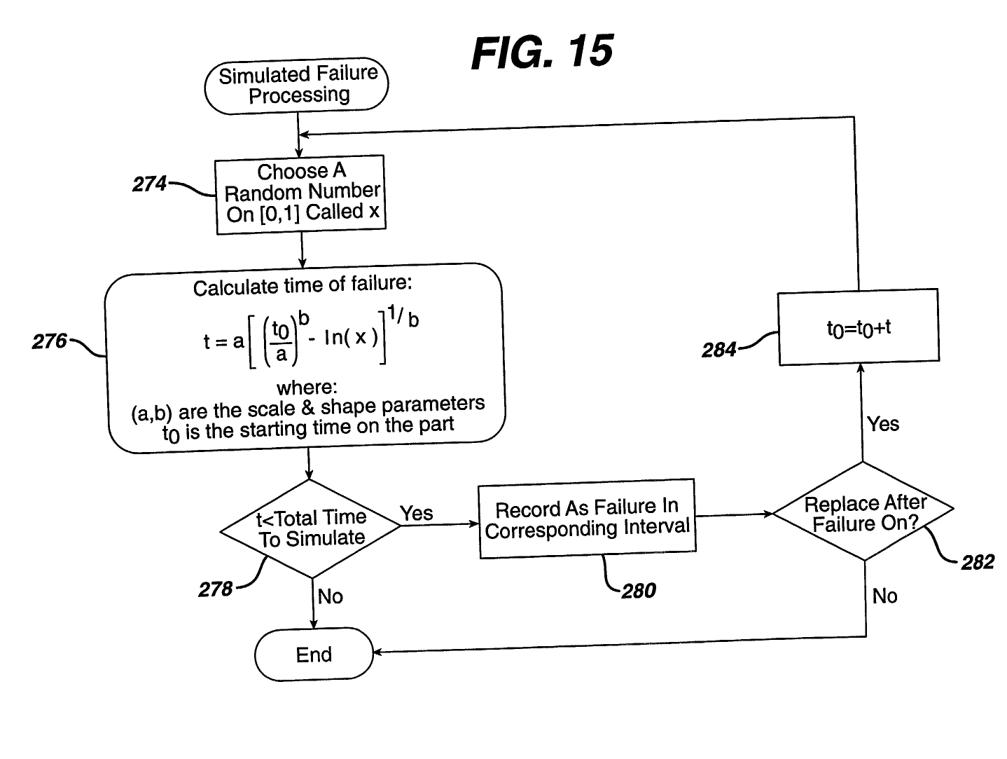

FIG. 15 shows a flow chart describing the processing operations associated with the Simulated Failure analysis set forth in FIG. 14. The Simulated Failure analysis begins at 274, where the interactive graphics-based reliability analysis tool chooses a random number between zero and one and designates it as x. Next, the interactive graphics-based reliability analysis tool determines the time of failure at 276 using the following equation:

$$t = {a [ {( \frac{{t}_{0}}{a} )}^{b} - ln ( x ) ]}^{\frac{1}{b}}$$

where (a,b) are the scale and shape parameters and t₀ is the starting time on the part. The interactive graphics-based reliability analysis tool then determines whether t is less than the total time to perform the simulation at 278. If the t is greater than the total time to simulate, then the analysis ends. Otherwise, the interactive graphics-based reliability analysis tool records this time as a failure at 280. Next, the interactive graphics-based reliability analysis tool determines whether a part should be replaced after a failure at 282. If there is no replacement, the analysis ends, otherwise the interactive graphics-based reliability analysis tool sets t₀ equal t₀ plus t at 284. The interactive graphics-based reliability analysis tool then repeats blocks 274-282 until there is no replacement after a failure.

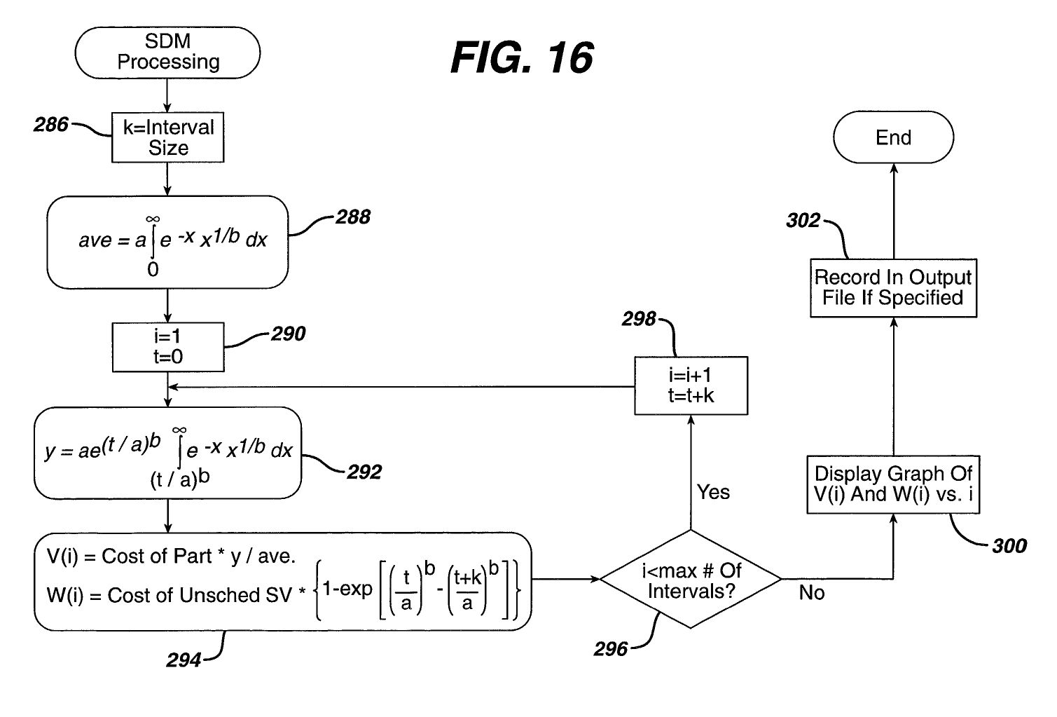

FIG. 16 shows a flow chart describing the processing operations associated with the Strategically Driven Maintenance (SDM) analysis set forth in FIG. 10d. The Strategically Driven Maintenance begins at 286 where the interactive graphics-based reliability analysis tool sets k equal to the selected interval size. For example, k might be the time between scheduled shop visits, where the user must determine whether to replace the part in question or wait until the next scheduled shop visit. Next, the interactive graphics-based reliability analysis tool determines ave at 288 which is the expected life of the part using the following equation:

$$ave = a {\int }_{0}^{∞} {ⅇ}^{- x} {x}^{1 / b} ⅆ x$$

The interactive graphics-based reliability analysis tool then sets i equal to one and t equal to zero at 290 and determines y at 292, which is expected remaining life on the part after time t using the following equation:

$$y = a {ⅇ}^{{( t / a )}^{b}} {\int }_{{( t / a )}^{b}}^{∞} {ⅇ}^{- x} {x}^{1 / b} ⅆ x$$

The interactive graphics-based reliability analysis tool then determines at 294 V(i) and W(i), which are the residual value of the part and the expected cost of an unexpected failure before the next scheduled shop visit, respectively, using the following equations:

V(i)=Cost of Part*y/ave

$$W ( i ) = \text{Cost of Unscheduled} \text{SV} * \{ 1 - exp [ {( \frac{t}{a} )}^{b} - {( \frac{t + k}{a} )}^{b} ] \}$$

where both Cost of Unscheduled SV (i.e., the general cost of an unscheduled shop visit) and Cost of Part are supplied as input by the user. The interactive graphics-based reliability analysis tool then determines at 296 whether i is less than the maximum number of intervals. If i is less than the maximum number of intervals, then the interactive graphics-based reliability analysis tool sets i equal to i plus one and t equal to t plus k at 298. Blocks 292-296 are repeated until the maximum number of intervals is greater than i. At this point, the interactive graphics-based reliability analysis tool then displays a graph of V(i) and W(i) at 300. If specified, the interactive graphics-based reliability analysis tool then puts the record in an output file at 302 and ends the Strategically Driven Maintenance analysis.

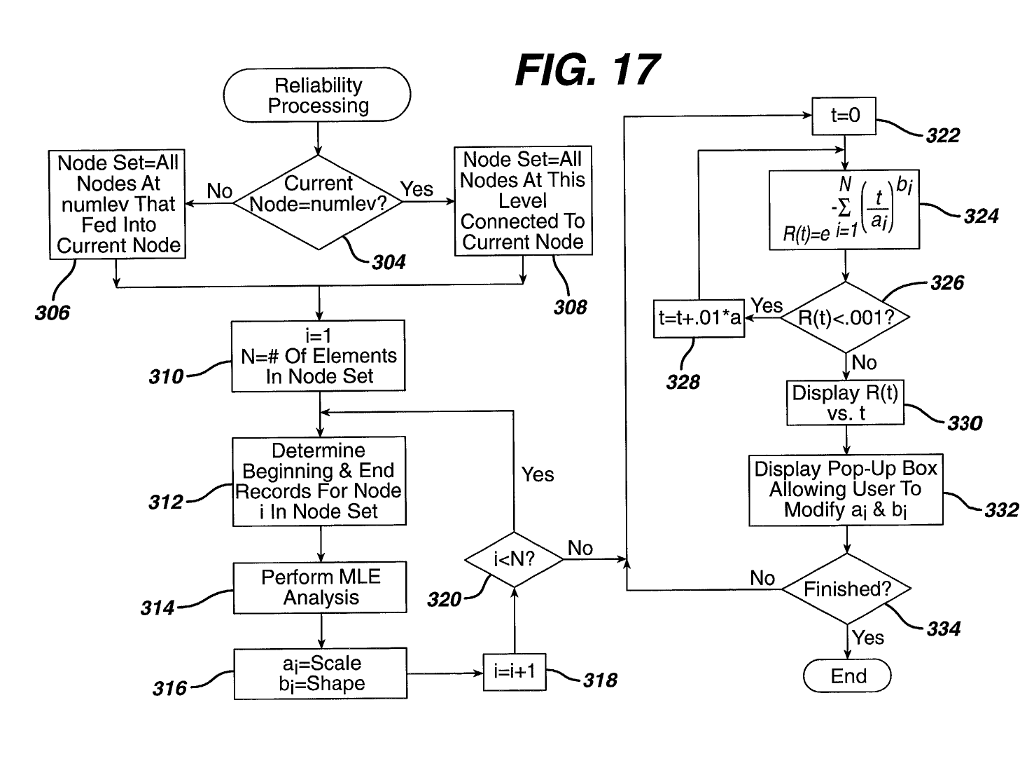

FIG. 17 shows a flow chart describing the processing operations associated with Reliability analysis set forth in FIG. 10d. The reliability analysis begins at 304 where the interactive graphics-based reliability analysis tool determines whether the current node equals the numlev. If the current node does not equal numlev, then the interactive graphics-based reliability analysis tool sets node equal to all of the nodes at numlev that feed into the current node at 306. However, if the current node does equal numlev, then the interactive graphics-based reliability analysis tool sets node equal to all of the nodes at the level connected to the current node at 308. After performing either block 306 or 308, the interactive graphics-based reliability analysis tool then sets i equal to one and N equal to the number of elements in the node set at 310. Next, the interactive graphics-based reliability analysis tool determines the beginning and end records for node i in the node set at 312 and performs the MLE analysis at 314. The interactive graphics-based reliability analysis tool then sets aᵢ equal to scale and bᵢ equal to shape at 316 and sets i equal to i plus one at 318. If i is less than N than as determined at 320, then blocks 312-320 are repeated until i is greater than or equal to N.

The reliability processing operations continue at 322, where the interactive graphics-based reliability analysis tool sets t equal to zero and determines R(t) at 324 which is the probability that the system will survive until time t, using the following equation:

$$R ( t ) = {ⅇ}^{- {\sum }_{i = 1}^{N} {( \frac{t}{{a}_{i}} )}^{{b}_{i}}}$$

If R(t) is less than 0.001 as determined at 326, then the interactive graphics-based reliability analysis tool determines t at 328 using the following equation:

t=t+0.01*a

The interactive graphics-based reliability analysis tool then repeats blocks 324-326 until R(t) is greater than or equal to 0.001. At this point, the interactive graphics-based reliability analysis tool then displays a plot of R(t) versus t at 330 and displays a pop-up box at 332 that allows a user to modify aᵢ and bᵢ. If the user is not finished with the reliability processing, then blocks 322-334 are repeated until finishing with the processing.

The foregoing flow diagram of FIGS. 7-17 shows the functionality and operation of the interactive graphics-based reliability analysis tool. In this regard, each block represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Furthermore, the functions can be implemented in programming languages such as Visual Basic and C; however, other languages such as C++ or JAVA can be used.

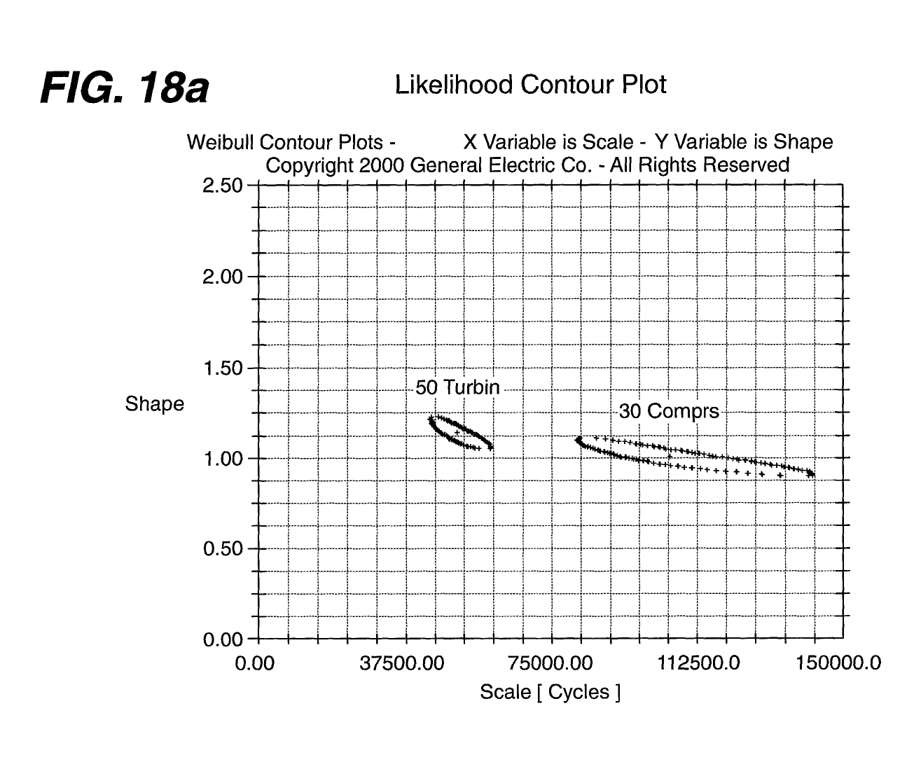

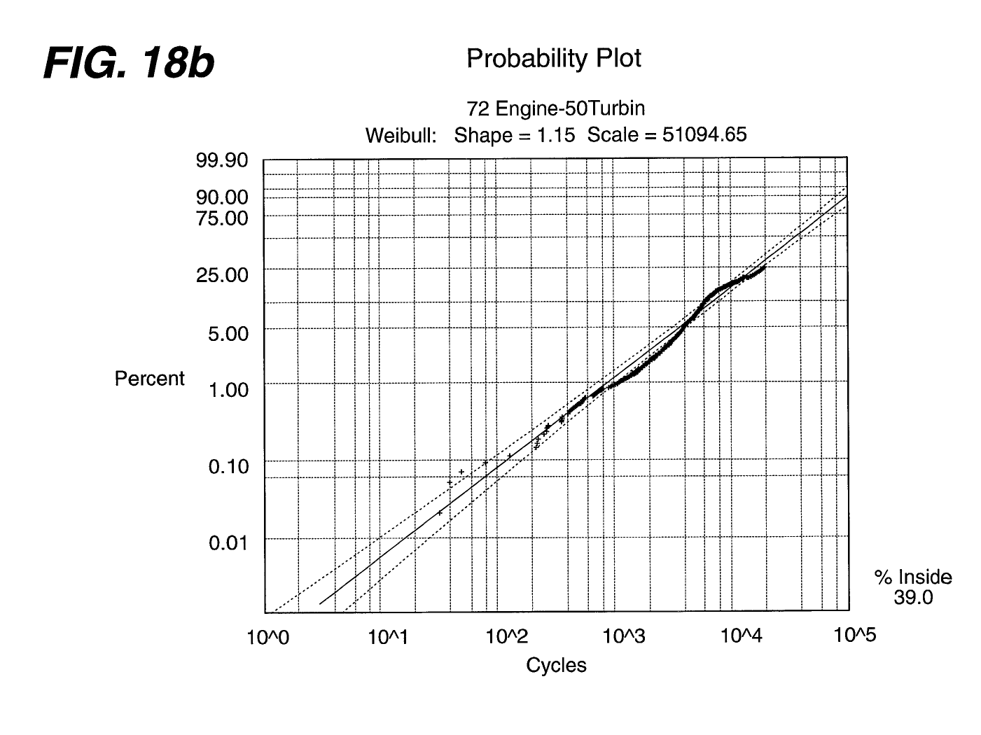

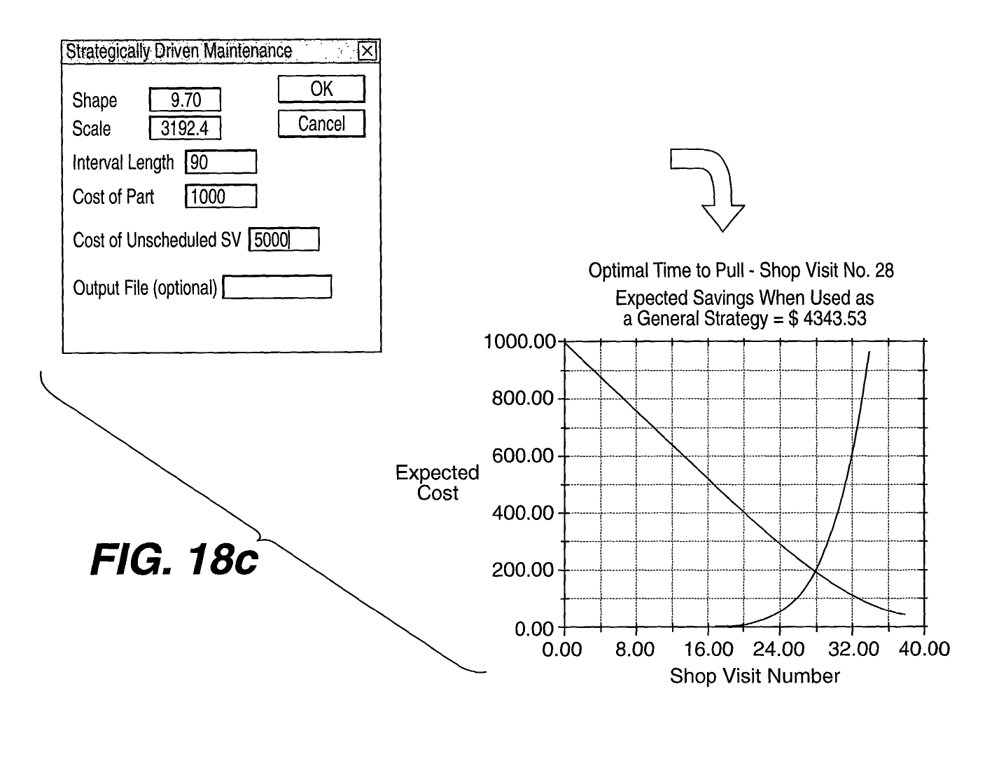

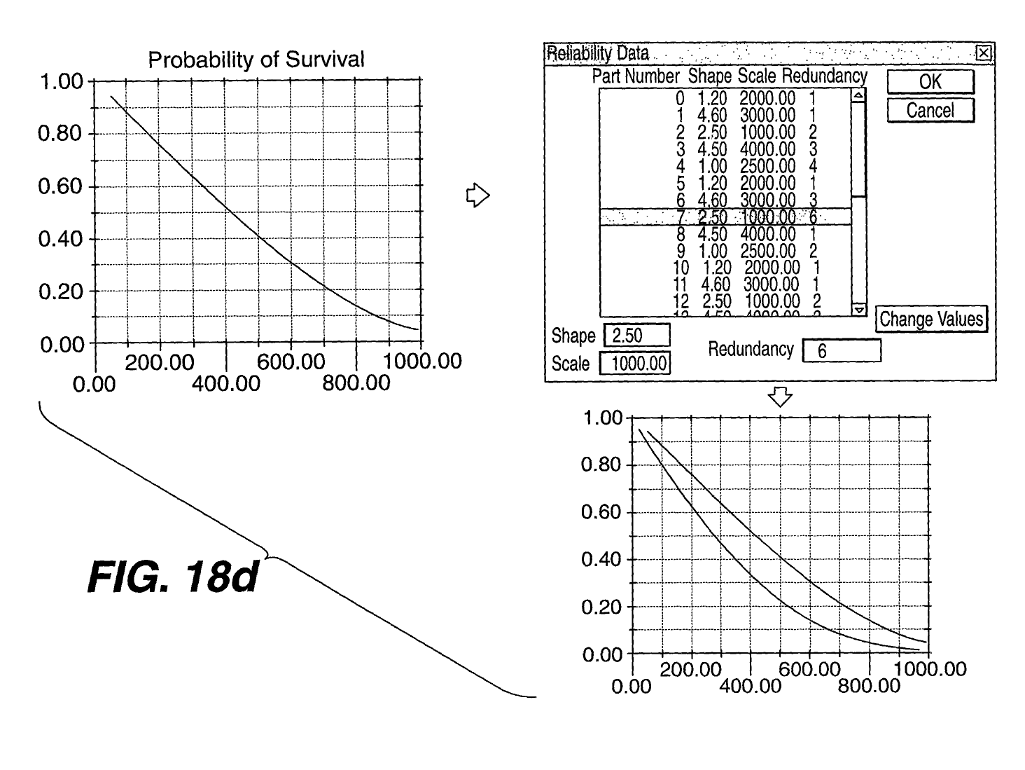

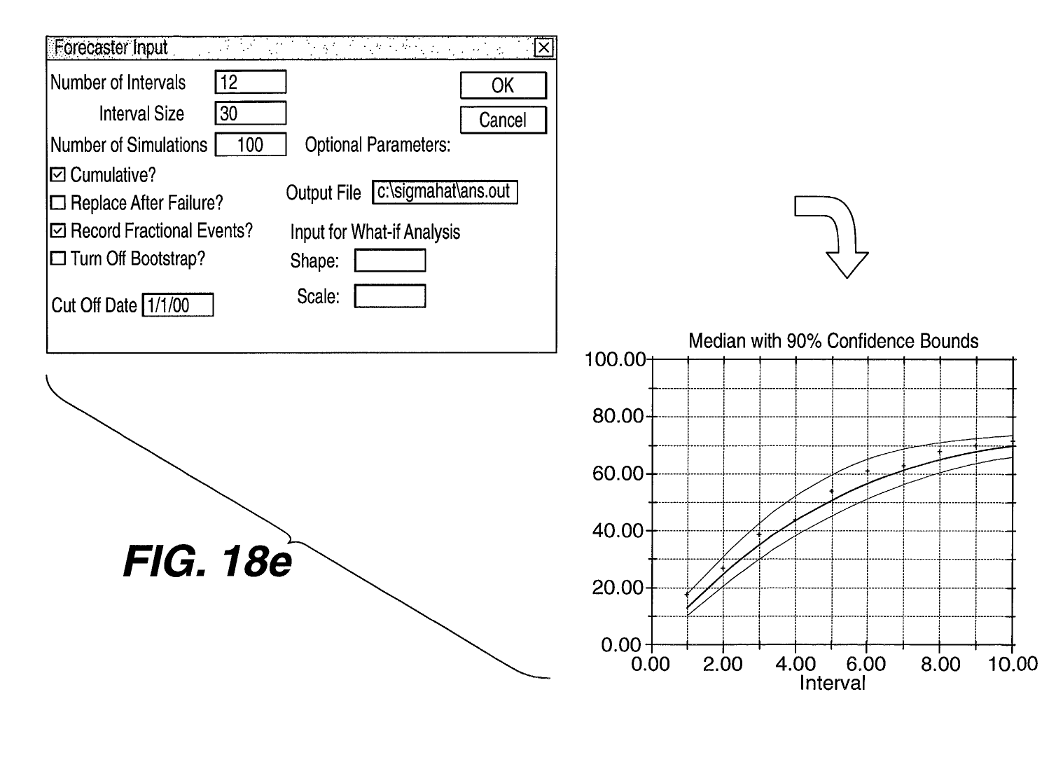

As mentioned above, the visualization component 36 of FIG. 2 provides a visualization of the analyses performed to the user. FIGS. 18a-18e show examples of various analyses presented to a user of the interactive graphics-based reliability analysis tool 28 shown in FIG. 2. FIGS. 18a-18b show various plots after selecting either the Weibull or Lognormal analysis. In particular, FIGS. 18a and 18b display likelihood contour and probability plots, respectively. These plots enable a user to determine the goodness of fit and the statistical significance of differences between various segments of data. FIG. 18c shows some of the visual aspects of the strategically driven maintenance analysis. In particular, FIG. 18c shows a dialog box that prompts a user to enter an interval length for examining a system, subsystem, or component, the cost of servicing the item under review and the cost of any unscheduled service event. The output results in an optimal time to pull graph and an estimate of the expected savings. On this graph two functions are plotted. The decreasing function shows the residual value of the part over time, and the increasing function shows the expected cost of an unexpected failure over time. The point at which these two curves cross provides the optimal point at which to proactively pull the part. FIG. 18d shows a plot of probability of survival versus time that may be displayed to a user after a reliability analysis is selected. In addition, the user has the option of viewing data associated with each of the individual components that make up the system reliability. This option may be presented to a user in the form of a dialog box. By using this option, a user can perform “what-if” analyses by modifying the input and viewing the results. FIG. 18e shows some of the visual aspects associated with the long term service agreement and inventory forecasting analysis. In particular, FIG. 18e shows a dialog box that prompts a user to enter a number of intervals and interval size (where interval is a specified number of days), number of simulations, cutoff date for analysis and various other options. The forecasting analysis uses this information to forecast the number of future service events over time, which enables a user to make long term service agreements and inventory decisions.

Another feature of the visualization component 36 is that it can display a movie mode of the analyses to a user. A movie mode display is a succession of similarly spatially registered screen displays; the individual displays displayed one immediately after the other in rapid succession. Any changes in the successively displayed contents will be visible to the eye as apparent movement. One instance where the movie mode display can be used is for displaying the movie mode of the shape and scale of a Weibull analysis. In order to provide the movie mode feature, the visualization component 36 uses a sliding window on the time-ordered data. The sliding window's width is set by an input parameter and is less than the data record length. The sliding window performs the Weibull analysis over the data in its window, displays the results of the analysis, then advances the window by an advancement that is also set by the input parameter, performs the Weibull analysis, refreshes the display with the most recent analysis and continues until the data window runs into the end of the data. An advantage of the movie mode display is that trends may sometimes be easily spotted as the maximum likelihood estimator point may be seen to trend or move in a preferred direction as the movie is shown. Another advantage is that an identified point within a closed curve may be seen to migrate in a definite direction as the data is examined over time.

Below is an example of the movie mode display feature in operation for data that comprises data points or datasets labeled D1, D2, D3, D4, D5, where Di occurs later than Dj, if and only if i>j. If a user specifies a window width of length 3, then the movie mode display feature would first compute the Weibull over D1, D2, D3. Next, the movie mode display feature would display the results and then compute the Weibull over D2, D3, D4. The movie mode display feature then displays these results, overwriting the previous displayed results. Next, the movie mode display feature compute the Weibull over D3, D4, D5 and displays the results by overwriting the previously displayed results.

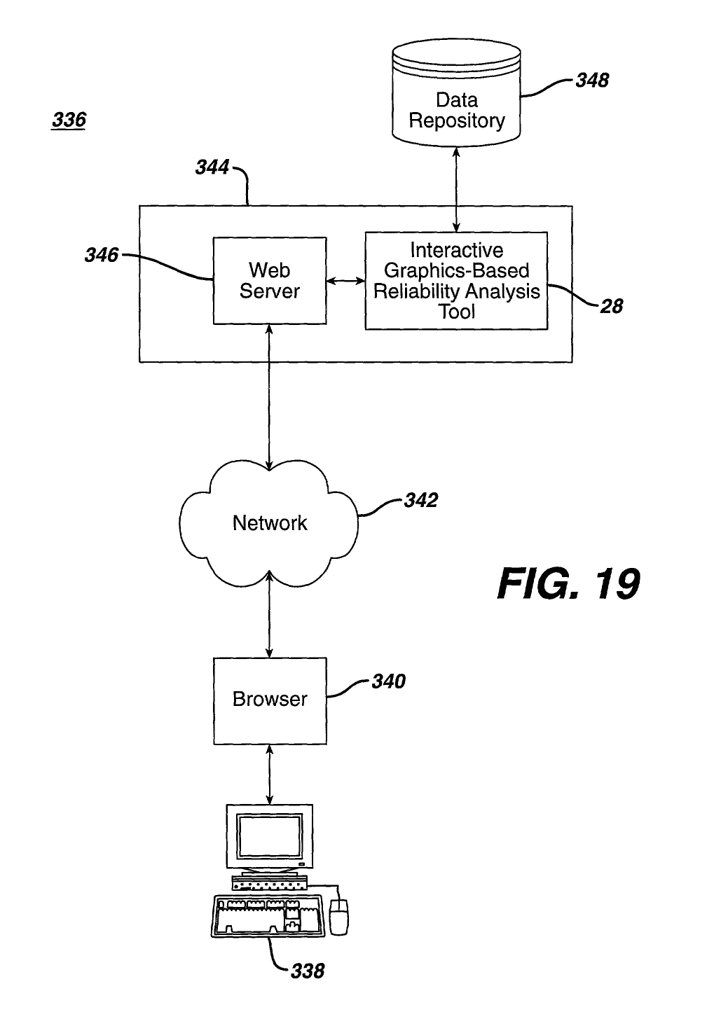

FIG. 19 shows an architectural diagram of a system 336 for implementing the interactive graphics-based reliability analysis tool 28 shown in FIG. 2 on a network. In FIG. 19, a computing unit 338 allows a user to access the interactive graphics-based reliability analysis tool 28. The computing unit 338 can take the form of a hand-held digital computer, personal digital assistant computer, notebook computer, personal computer or workstation. The user uses a web browser 340 such as Microsoft INTERNET EXPLORER, Netscape NAVIGATOR or Mosaic to locate and display the interactive graphics-based reliability analysis tool 28 on the computing unit 338. A communication network 342 such as an electronic or wireless network connects the computing unit 338 to the interactive graphics-based reliability analysis tool 28. In particular, the computing unit 338 may connect to the interactive graphics-based reliability analysis tool 28 through a private network such as an extranet or intranet or a global network such as a WAN (e.g., Internet). As shown in FIG. 19, the interactive graphics-based reliability analysis tool 28 resides in a server 344, which comprises a web server 346 that serves the interactive graphics-based reliability analysis tool 28 and a data repository 348 that contains a plurality of service information. However, the interactive graphics-based reliability analysis tool does not have to be co-resident with the server 344.

If desired, the system 336 may have functionality that enables authentication and access control of users accessing the interactive graphics-based reliability analysis tool 28. Both authentication and access control can be handled at the web server level by the interactive graphics-based reliability analysis tool 28 itself, or by commercially available packages such as Netegrity SITEMINDER. Information to enable authentication and access control such as the user names, location, telephone number, organization, login identification, password, access privileges to certain resources, physical devices in the network, services available to physical devices, etc. can be retained in a database directory. The database directory can take the form of a lightweight directory access protocol (LDAP) database; however, other directory type databases with other types of schema may be used including relational databases, object-oriented databases, flat files, or other data management systems.

In FIG. 19 there is a data repository 348 that stores service data such as configuration information, data related to the system such as definitions of the subsystems and components. The configuration information may include information for customers, system models, users, Weibull distribution model parameters, storage requirements, etc. The data repository 348 may also contain historical service information such as the date that the system and subsystems were first put into service, components that have experienced failures, dates that the components experienced the failures and the position or positions of the failed components with respect to the other components. In addition, the data repository 348 may comprise other service data such as changes made to the components, repair history of the product (e.g., dates of service events, types of service events, etc.), and factors which may play a role in explaining the length of time which passes between service events (e.g., environment, operating conditions of the subsystems and components, product configurations, etc.). In the above system, the service information may either be inputted manually or as part of an automatic data collection system.

In this implementation, the interactive graphics-based reliability analysis tool 28 runs on the web server 346 in the form of servlets, which are applets (e.g., Java applets) that run a server. Alternatively, the interactive graphics-based reliability analysis tool 28 may run on the web server in the form of CGI (Common Gateway Interface) programs. The servlets access the data repository 348 using JDBC or Java database connectivity, which is a Java application programming interface that enables Java programs to execute SQL (structured query language) statements. Alternatively, the servlets may access the data repository 348 using ODBC or open database connectivity. Using hypertext transfer protocol or HTTP, the web browser 340 obtains a variety of applets that execute the interactive graphics-based reliability analysis tool 28 on the computing unit 338.

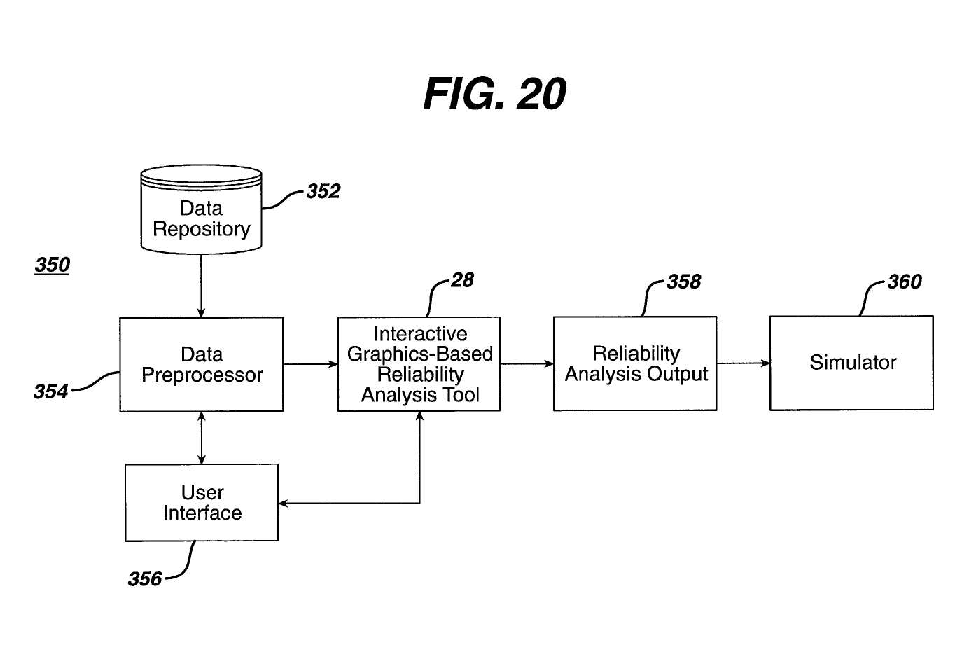

FIG. 20 shows an architectural diagram of an alternative embodiment for implementing the interactive graphics-based reliability analysis tool shown in FIG. 2. In particular, FIG. 20 shows a system 350 for performing reliability analysis on a complex system. Like the system shown in FIG. 19, the system comprises a data repository 352 such as an integrated data warehouse. The data repository 352 stores a plurality of service data. The data repository 352 like the one shown in FIG. 19 comprises information such as historical service information (e.g., dates that the system and subsystems were first put into service, components that have experienced failures, dates of failures, position(s) failures, etc.), configuration information, other service data (e.g., changes made to the components, repair history of the product, and factors which influence service events.

A data preprocessor 354 acquires the data in the data repository 352 and preprocesses the data. The data preprocessor 354 acquires the data residing in the data repository 352 through a user database access method. For example, data repository 352 may be a Microsoft Access type database and the user may specify which data items need to be provided to the data preprocessor 354 by utilizing Microsoft Access. Some of the preprocessing functions performed by the data preprocessor 354 include separating parts which were replaced due to a previously defined schedule and parts which were replaced unexpectedly due to failures. Fields in data repository 352 indicate whether the replacement was scheduled or not. Unscheduled events are referred to as failures and scheduled events are referred to as censored times. In addition, the data preprocessor 354 determines which systems have run to-date without a failure, and these times are added to the list of censored times. The data preprocessor 354 may also segment the data according to user specified parameters such as geographic location, fleet information, etc., which is provided through a user interface 356.

The interactive graphics-based reliability analysis tool 28 enables a user to perform any one of the above-mentioned analyses on the preprocessed data. In particular, the user can use the interactive graphics-based reliability analysis tool 28 to characterize the reliability of a complex system at all levels. This includes predicting the rate at which a system (i.e., subsystem and/or components) will fail, determining the cost of the system over its entire life span, forecasting risk for long term service agreement pricing and monitoring of the system. A reliability analysis output component 358 generates outputs of any of the above-described analyses (e.g., Weibull or Lognormal analysis, Strategically Driven Maintenance analysis, reliability analysis, long term service agreement and inventory forecasting analysis, etc.). The system 350 shown in FIG. 20 also includes a simulator 360 that simulates the reliability of the system according to the reliability analysis output 358.

Another aspect of the system 350 shown in FIG. 20 is that the user interface 356 enables it to function as an interactive preprocessing tool that can perform automated processing at any level of a hierarchical representation. In particular, instead of a user having to navigate to each node at a certain level of the hierarchy and selecting an analysis routine (e.g., a Weibull analysis), the user can indicate during the preprocessing stage that a particular analysis is to be performed for all nodes at level n of the hierarchical representation. This feature is particularly useful for long term service agreement pricing and inventory forecasting analysis where the hierarchical representation may comprise a (1) major assembly, (2) sub assembly and (3) fleet. For example, consider the situation where the user wants to select the Weibull analysis. In this example, the system 350 first performs a default Weibull analysis for all components at the subsystem level of the hierarchical representation. Once this is completed and the values from the default Weibull analysis are recorded, the user may choose to navigate to a particular sub assembly and examine the contours for all fleets which make up that sub assembly through the user interface 356. If some fleets are statistically different than others (i.e., their contours do not overlap), then they may be analyzed separately and the resulting Weibull parameters will override the default values for that sub assembly. One of ordinary skill in the art will recognize that this aspect of FIG. 20 is not limited to use of the Weibull analysis. Instead, the interactive preprocessing feature can be used with any of the above-mentioned analysis options to analyze any of nodes at level n of the hierarchical representation.

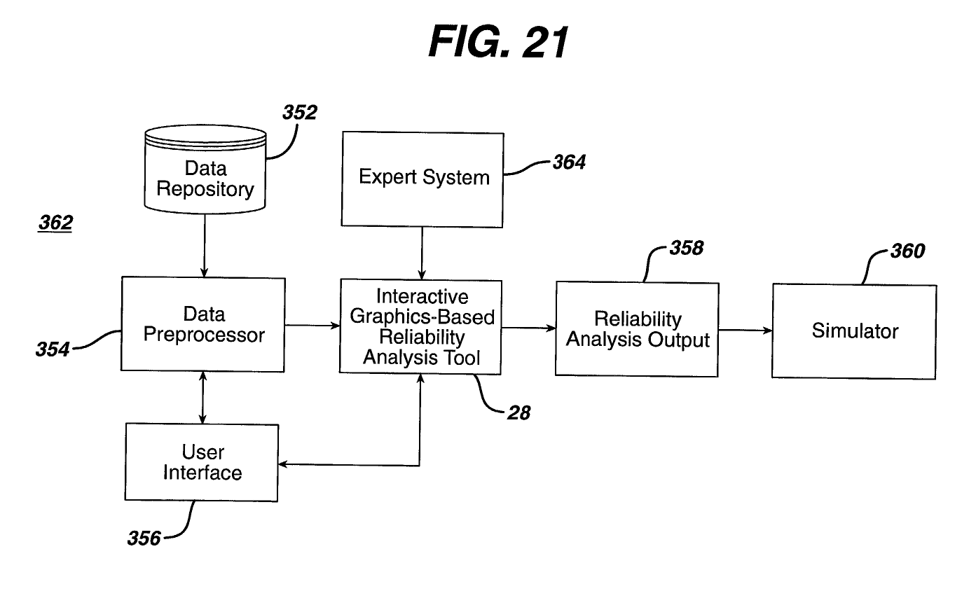

FIG. 21 shows an architectural diagram of another alternative embodiment for implementing the interactive graphics-based reliability analysis tool shown in FIG. 2. In particular, FIG. 21 shows a system 362 for performing reliability analysis on a complex system. The system 362 is similar to the one shown in FIG. 20, except that an expert system 364 has been added. The expert system 364 generally comprises a knowledge base or rule base that is implemented with a knowledge processor or rule interpreter. In operation, the knowledge processor or rule interpreter quickly finds information in the knowledge base or rule base to analyze the hierarchical representation.

The expert system 364 serves several purposes. One aspect of the expert system 364 is for “drilling down” in the hierarchical representation. In particular, the expert system 364 allows a user to select how far down in the hierarchical representation that they want to perform any one of the above-mentioned analysis options. For example, in order to characterize the reliability of an entire system, a user may choose to drill down only as far as necessary in the hierarchical representation in order to get a good statistical fit to the data. In such a scenario, the operation would proceed automatically in the following manner. First, a Weibull analysis would be performed at the top level (i.e., no drill down). If the Weibull fit is good (e.g., 90% of the points fall within the confidence intervals), then the expert system 364 will stop the operation. However, if the Weibull fit is not good, then the expert system 364 ensure that a Weibull analysis is performed for all nodes at the major assembly level. If any of these Weibull fits are good, then these values are retained. For each node at the major assembly level that had a bad fit, the expert system 364 ensures that a Weibull analysis is performed for all nodes at the sub assembly level below that particular node. These steps are repeated until there are only good fits or the analysis is at the lowest level of the hierarchical representation.

Another aspect of the expert system 364 is to provide a set of rules for how various datasets should be combined or segmented for optimal value. These rules are the result of past experience. As a typical implementation, the expert system 364 may consider all possible combinations and segmentations of the input data and determine which combination or segmentation provides the overall best statistical fit. This information is then provided to the user via the user interface 356 to aid in the analysis. In many cases, the process of determining the optimal combinations and segmentations of the data may require multiple steps in which the expert system 364 performs a series of recommendations for data processing and analysis. A third aspect of the expert system 364 is for determining the right timing for updating any statistical models. For example, if new parameter estimates based on the latest data collected result in models that predict values significantly different than the predictions based on old parameter estimates, then the expert system 364 assesses the statistical significance of the difference between the two predictions and updates the models accordingly. One of ordinary skill in the art will recognize that the expert system 364 may perform other functions other than the ones previously described.

The above-described tool and systems comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided in accordance with this invention, an interactive graphics-based reliability analysis tool for performing reliability analysis of a system. While the invention has been particularly shown and described in conjunction with a preferred embodiment thereof, it will be appreciated that variations and modifications can be effected by a person of ordinary skill in the art without departing from the scope of the invention.

What is claimed is:

1. An interactive graphics-based tool for performing a reliability analysis on a system having a plurality of subsystems and a plurality of components within each subsystem, comprising:
a hierarchical representation component that organizes the system and the plurality of subsystems and components into a hierarchical representation;
an interactive selection component that provides a plurality of options for analyzing the hierarchical representation; and
a reliability analysis component, responsive to the hierarchical representation component and the interactive selection component, that performs a reliability analysis at any level of the hierarchical representation.

2. The tool according to claim 1, wherein the hierarchical representation generated by the hierarchical representation component takes the form of a tree structure wherein the system and plurality of subsystems and components are represented in the tree structure by a node.

3. The tool according to claim 2, wherein the plurality of options provided by the interactive selection component comprises at least one of moving about the hierarchical representation, selecting a node and defining a group of nodes.

4. The tool according to claim 1, wherein the reliability analysis component performs at least one of a statistical analysis, reliability prediction, life cycle cost analysis, maintenance projections, and inventory forecasting.

5. The tool according to claim 1, further comprising a visualization component that provides a visualization of the reliability analysis.

6. The tool according to claim 5, wherein the visualization component comprises a movie mode display.

7. An interactive graphics-based tool for performing a reliability analysis on a system having a plurality of subsystems and a plurality of components within each subsystem, comprising:
a hierarchical representation component that organizes the system and the plurality of subsystems and components into a hierarchical representation;
an interactive selection component that provides a plurality of options for analyzing the hierarchical representation;
a reliability analysis component, responsive to the hierarchical representation component and the interactive selection component, that performs a reliability analysis at any level of the hierarchical representation; and
a visualization component that provides a visualization of the reliability analysis in a graphical framework.

8. The tool according to claim 7, wherein the hierarchical representation generated by the hierarchical representation component takes the form of a tree structure wherein the system and plurality of subsystems and components are represented in the tree structure by a node.

9. The tool according to claim 8, wherein the plurality of options provided by the interactive selection component comprises at least one of moving about the hierarchical representation, selecting a node and defining a group of nodes.

10. The tool according to claim 7, wherein the reliability analysis component performs at least one of a statistical analysis, reliability prediction, life cycle cost analysis, maintenance projections, and inventory forecasting.

11. The tool according to claim 7, wherein the visualization component comprises a movie mode display.

12. A graphics-based tool for performing a reliability analysis on a system having a plurality of subsystems and a plurality of components within each subsystem, comprising:
means for organizing the system and the plurality of subsystems and components into a hierarchical representation;
means for providing a plurality of options for analyzing the hierarchical representation;
means, responsive to the organizing means and the providing means, for performing a reliability analysis at any level of the hierarchical representation; and
means for generating a visualization of the reliability analysis in a graphical framework.

13. The tool according to claim 12, wherein the hierarchical representation generated by the organizing means takes the form of a tree structure wherein the system and plurality of subsystems and components are represented in the tree structure by a node.

14. The tool according to claim 13, wherein the plurality of options provided by the providing means comprises at least one of moving about the hierarchical representation, selecting a node and defining a group of nodes.

15. The tool according to claim 12, wherein the reliability analysis means performs at least one of a statistical analysis, reliability prediction, life cycle cost analysis, maintenance projections, and inventory forecasting.

16. A system for performing a reliability analysis on a system having a plurality of subsystems and a plurality of components within each subsystem, comprising:
a data repository containing a plurality of service data for the system;
an interactive data preprocessor that preprocesses the plurality of service data in accordance with a user specified reliability analysis selection; and
an interactive graphics-based tool for performing the user specified reliability analysis on the system in accordance with the plurality of service data, the interactive graphics-based tool comprising a hierarchical representation component that organizes the system and the plurality of subsystems and components into a hierarchical representation; an interactive selection component that provides a plurality of options for analyzing the hierarchical representation; a statistical analysis component, responsive to the hierarchical representation component and the interactive selection component, that performs a statistical analysis at any level of the hierarchical representation; and a visualization component that provides a visualization of the statistical analysis in a graphical framework.

17. The system according to claim 16, further comprising an expert system that assists the interactive graphics-based tool in performing the reliability analysis.

18. The system according to claim 16, wherein the data preprocessor performs at least one of determining censoring times, filtering data and segmenting data.

19. A system for performing a reliability analysis on a system having a plurality of subsystems and a plurality of components within each subsystem, comprising:
a data repository containing a plurality of service data for the system;
an interactive graphics-based tool for performing a statistical analysis on the system in accordance with the plurality of service data, the interactive graphics-based tool comprising a hierarchical representation component that organizes the system and the plurality of subsystems and components into a hierarchical representation; an interactive selection component that provides a plurality of options for analyzing the hierarchical representation; a statistical analysis component, responsive to the hierarchical representation component and the interactive selection component, that performs a statistical analysis at any level of the hierarchical representation; and a visualization component that provides a visualization of the statistical analysis in a graphical framework; and
a first computing unit configured to serve the data repository and the interactive graphics-based tool.

20. The system according to claim 19, wherein the data repository stores historical failure data for the system.

21. The system according to claim 19, further comprising a simulator that simulates the reliability of the plurality of service data in accordance with the statistical model.

22. The system according to claim 19, further comprising an expert system that assists the interactive graphics-based tool in performing the statistical analysis.

23. The system according to claim 19, further comprising a data preprocessor that preprocesses the plurality of service data.

24. The system according to claim 19, further comprising a second computing unit configured to interact with the data repository and the interactive graphics-based tool served from the first computing unit over a network.

25. A method for performing a reliability analysis on a system having a plurality of subsystems and a plurality of components within each subsystem, comprising:
organizing the system and the plurality of subsystems and components into a hierarchical representation;
providing a plurality of options for analyzing the hierarchical representation; and
performing a reliability analysis at any level of the hierarchical representation.

26. The method according to claim 25, wherein the hierarchical representation takes the form of a tree structure wherein the system and plurality of subsystems and components are represented in the tree structure by a node.

27. The method according to claim 26, wherein the plurality of options comprises at least one of moving about the hierarchical representation, selecting a node and defining a group of nodes.

28. The method according to claim 25, wherein the performing a reliability analysis comprises performing at least one of a statistical analysis, reliability prediction, life cycle cost analysis, maintenance projections, and inventory forecasting.

29. The method according to claim 25, wherein the performing a reliability analysis comprises visualizing the reliability analysis.

30. The method according to claim 29, wherein the visualizing a reliability analysis comprises generating a movie mode display.

31. A method for performing a reliability analysis on a system having a plurality of subsystems and a plurality of components within each subsystem, comprising:
organizing the system and the plurality of subsystems and components into a hierarchical representation;
providing a plurality of options for analyzing the hierarchical representation;
performing a reliability analysis at any level of the hierarchical representation; and
visualizing the reliability analysis in a graphical framework.

32. The method according to claim 31, wherein the hierarchical representation takes the form of a tree structure wherein the system and plurality of subsystems and components are represented in the tree structure by a node.

33. The method according to claim 32, wherein the plurality of options comprises at least one of moving about the hierarchical representation, selecting a node and defining a group of nodes.

34. The method according to claim 31, wherein the performing of the reliability analysis comprises performing at least one of a statistical analysis, reliability prediction, life cycle cost analysis, maintenance projections, and inventory forecasting.

35. The method according to claim 31, wherein the visualizing a reliability analysis comprises generating a movie mode display.

36. A method for performing a reliability analysis on a system having a plurality of subsystems and a plurality of components within each subsystem, comprising:
storing a plurality of service data for the system;
preprocessing the plurality of service data in accordance with a user specified reliability analysis selection; and
providing an interactive graphics-based tool for performing the user specified reliability analysis on the system in accordance with the plurality of service data.

37. The method according to claim 36, wherein the preprocessing comprises performing at least one of determining censoring times, filtering data and segmenting data.

38. The method according to claim 35, wherein the simulating predicts life cycle events and costs associated with each event.

39. A method for enabling a user to perform a reliability analysis on a system having a plurality of subsystems and a plurality of components within each subsystem, comprising:
prompting the user to organize the system and the plurality of subsystems and components into a hierarchical representation;
prompting the user to select from a plurality of analyzing options;
in response to the user selection, performing a reliability analysis at any level of the hierarchical representation; and
providing a visualization of the reliability analysis to the user in a graphical framework.

40. The method according to claim 39, wherein the hierarchical representation takes the form of a tree structure wherein the system and plurality of subsystems and components are represented in the tree structure by a node.

41. The method according to claim 40, wherein the plurality of options comprises at least one of moving about the hierarchical representation, selecting a node and defining a group of nodes.

42. The method according to claim 39, wherein the performing of the reliability analysis comprises performing at least one of a statistical analysis, reliability prediction, life cycle cost analysis, maintenance projections, and inventory forecasting.

43. A method for enabling a user to perform a reliability analysis on a system having a plurality of subsystems and a plurality of components within each subsystem, comprising:
storing a plurality of service data for the system;
prompting the user to specify a reliability analysis selection;
preprocessing the plurality of service data in accordance with the user specified reliability analysis selection; and
performing the user specified reliability analysis.

44. The method according to claim 43, wherein the performing of the user specified reliability analysis comprises prompting the user to organize the system and the plurality of subsystems and components into a hierarchical representation.

45. The method according to claim 44, wherein the performing of the user specified reliability analysis comprises prompting the user to select from a plurality of analyzing options.

46. The method according to claim 45, wherein the performing of the user specified reliability analysis comprises performing a reliability analysis at any level of the hierarchical representation in response to the user selection.

47. The method according to claim 46, wherein the performing of the user specified reliability analysis comprises providing a visualization of the reliability analysis to the user.

48. The method according to claim 43, further comprising performing a simulation.

49. The method according to claim 48, wherein the simulating predicts life cycle events and costs associated with each event.

50. A computer-readable medium storing computer instructions for instructing a computer system to perform a reliability analysis on a system having a plurality of subsystems and a plurality of components within each subsystem, the computer instructions comprising:
organizing the system and the plurality of subsystems and components into a hierarchical representation;
providing a plurality of options for analyzing the hierarchical representation;
performing a reliability analysis at any level of the hierarchical representation; and
visualizing the reliability analysis in a graphical framework.

51. The computer-readable medium according to claim 50, wherein the hierarchical representation takes the form of a tree structure wherein the system and plurality of subsystems and components are represented in the tree structure by a node.

52. The computer-readable medium according to claim 51, wherein the plurality of options comprises at least one of moving about the hierarchical representation, selecting a node and defining a group of nodes.

53. The computer-readable medium according to claim 50, wherein the performing of the reliability analysis comprises instructions for performing at least one of a statistical analysis, reliability prediction, life cycle cost analysis, maintenance projections, and inventory forecasting.

54. The computer-readable medium according to claim 50, wherein the visualizing a reliability analysis comprises generating a movie mode display.

55. A computer-readable medium storing computer instructions for instructing a computer system to enable a user to perform a reliability analysis on a system having a plurality of subsystems and a plurality of components within each subsystem, the computer instructions comprising:
prompting the user to organize the system and the plurality of subsystems and components into a hierarchical representation;
prompting the user to select from a plurality of analyzing options;
in response to the user selection, performing a reliability analysis at any level of the hierarchical representation; and
providing a visualization of the reliability analysis to the user.

56. A computer-readable medium storing computer instructions for instructing a computer system to enable a user to perform a reliability analysis on a system having a plurality of subsystems and a plurality of components within each subsystem, the computer instructions comprising:
storing a plurality of service data for the system;
prompting the user to specify a reliability analysis selection;
preprocessing the plurality of service data in accordance with the user specified reliability analysis selection; and
performing the user specified reliability analysis.

57. The computer-readable medium according to claim 56, further comprising instructions for performing a simulation.
